(19) United States
(12) Patent Application Publication
(10) Pub. No.: US 2010/0036792 A1
(43) Pub. Date: Feb. 11, 2010

(54) Image Processing Apparatus, Image Processing Method, and Computer Program

(76) Inventors: Tsutomu SAWADA, Tokyo (JP); Hiroaki Ogawa, Chiba (JP); Keiichi Yamada, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/496,847

(22) Filed: Jul. 2, 2009

(30) Foreign Application Priority Data
Aug. 7, 2008 (JP) P2008-177609

(51) Int. Cl. G06N 7/02

(52) U.S. Cl. 706/52

(57) ABSTRACT

An information processing apparatus includes information input units, an event detecting unit, and an information-integration processing unit. Observed values including user identification data are obtained based on image and sound information from the information input units such as a camera and a microphone. Target data set with plural user confidence factors is updated and user identification is then performed. The user identification information in the observed values is used for updating the simultaneous occurrence probability of candidate data by which targets are corresponded with respective users. The updated value of such probability is used for calculating the user confidence factors corresponding to the targets.

### BACKGROUND OF THE INVENTION

1. Field of the Invention

The present invention relates to an information-processing apparatus, an information-processing method, and a computer program. More particularly, the present invention relates to an information processing apparatus that receives an input of information from the outside, for example, information such as an image and sound, and executes an analysis of an external environment based on the input information, specifically processing for analyzing a position, identity, and the like of a person who is uttering words. The present invention also relates to an information processing method for executing such analytical processing in the information processing apparatus. The present invention further relates to a computer program for causing the information processing apparatus to execute the analysis processing.

2. Description of the Related Art

A system that performs processing between a person and an information processing apparatus such as a PC or a robot, for example, communication and interactive processing is called a man-machine interaction system. In the man-machine interaction system, the information processing apparatus such as the PC or the robot is inputted with image information or sound information and performs an analysis based on the input information in order to recognize actions of the person, for example, motions and words of the person.

When the person communicates information, the person utilizes not only words but also various channels such as a look and an expression as information communication channels. If analysis of such all the channels can be conducted in a machine, communication with people and a machine can also reach communication with people and a person, and this level. An interface that analyzes input information from such plural channels (also referred to as modalities or modals) is called a multi-modal interface, which has been actively developed and researched in recent years.

For example, when image information photographed by a camera and sound information acquired by a microphone is inputted and analyzed, to perform a more detailed analysis, it is effective to input a large amount of information from plural cameras and plural microphones set at various points.

As a specific system, for example, a system described below may be considered. It is possible to realize a system in which an information processing apparatus (a television) is inputted with an image and sound of users (a father, a mother, a sister, and a brother) in front of the television via a camera and a microphone, analyzes, for example, positions of the respective users and which of the users uttered words, and performs processing corresponding to analysis information, for example, zooming-in of the camera on the user who spoke or accurate response to the user who spoke.

Most of general man-machine interaction systems in the past perform processing for deterministically integrating information from plural channels (modals) and determining where respective plural users are present, who the users are, and who uttered a signal. Examples of a related art that discloses such a system include Japanese Unexamined Patent Application No. 2005-271137 and Japanese Unexamined Patent Application No. 2002-264051.

However, a method of processing for deterministically integrating information using uncertain and asynchronous data inputted from a microphone and a camera performed in a system in the past lacks robustness. Only less accurate data is obtained with the method. In an actual system, sensor information that can be acquired in an actual environment, i.e., an input image from a camera and sound information inputted from a microphone are uncertain data including various extra information, for example, noise and unnecessary information. When an image analysis and a sound analysis are performed, processing for efficiently integrating effective information from such sensor information is important.

### SUMMARY OF THE INVENTION

Accordingly, it is an object of the present invention to provide an information processing apparatus, an information processing method, and a computer program. They are provided for improving robustness and performing a highly accurate analysis by performing probabilistic processing for uncertain information included in various kinds of input information such as image and sound information to perform processing for integrating the information into information estimated to be higher in accuracy in a system that performs an analysis of input information from plural channels (modalities or modals) and specifically, for example, processing for identifying a person around the system.

Furthermore, it is an object of the present invention is to provide an information-processing apparatus, an information-processing method, and a computer program, which are provided for integrating uncertain and asynchronous positional information and identification information constructed of a plurality of modals in a statistical manner. When presuming where plural targets are located and who they are, simultaneous occurrence probability (Joint Probability) of user IDs for all the targets can be calculated while excluding independency between the targets. The information-processing apparatus, the information-processing method, and the computer program can be provided with improved estimation performance for user identification and high precision analysis.

A first embodiment of the present invention is an information processing apparatus, including a plurality of information input units, an event detecting unit, and an information-integration processing unit.

The plurality of information input units is provided for inputting information including image information or sound information in an actual space.

The event detecting unit is provided for generating event information including estimated identification information of users present in the actual space by analyzing the information inputted from the information input unit.

The information-integration processing unit is provided for setting probability distribution data of hypotheses concerning identification information of the users and executes processing of identifying the users present in the actual space by updating and selecting the hypotheses on the basis of the event information.

The information-integration processing unit executes processing for updating target data including user confidence factor information that indicates which of the users corresponds to a target provided as the event occurrence source on the basis of user identification information included in the event information.

The information-integration processing unit executes processing for calculating the user confidence factor by applying a limitation of that identical user does not present simultaneously to the processing for updating the target data.

In the information processing apparatus of the embodiment of the present invention, the information-integration processing unit updates the simultaneous occurrence probability (joint probability) of candidate data that allows the targets to corresponding to the respective users on basis of user identification information included in the event information. Then, the information-integration processing unit applies the updated value of simultaneous occurrence probability to processing for calculating a user confidence factor corresponding to a target and executes such processing.

In the information processing apparatus of the embodiment of the present invention, furthermore, the information-integration processing unit marginalizes the value of the updated simultaneous occurrence probability on the basis of user identification information included in the event information to calculate the confidence factor of an user identifier corresponding to each target.

In the information processing apparatus of the embodiment of the present invention, furthermore, the information-integration processing unit performs initial setting for the simultaneous occurrence probability (Joint Probability) of candidate data that allows the targets to corresponding to the respective users on the basis of a limitation of that the same user identifier (User ID) is not allocated to plural targets. The probability value of the simultaneous occurrence probability P(Xu) of candidate data, where the same user identifier (User ID) is set to different targets, is P(Xu)=0.0; and the probability value of other target data is P(Xu)=0.0<P≦1.0.

In the information processing apparatus of the embodiment of the present invention, furthermore, the information-integration processing unit executes exceptional-setting processing. That is, the exceptional-setting processing is that the probability value of the simultaneous occurrence probability P(Xu) is P(Xu)=0.0<P≦1.0 even if the same user identifier (User ID-unknown) is set to different targets with respect to an unregistered user set with a user identifier (User ID-unknown).

In the information processing apparatus of the embodiment of the present invention, furthermore, the information-integration processing unit deletes the candidate data where the same user identifier (User ID) is set to different targets, while only leaving other candidate data, and only the remaining candidate data is provided as an update subject on the basis of the event information.

In the information processing apparatus of the embodiment of the present invention, furthermore, the information-integration processing unit employs a probability value calculated using a formula:

P(Xuₜ|θₜ,zuₜ,Xuₜ₋₁)=R×P(θₜ,zuₜ|Xuₜ)P(Xuₜ₋₁|Xuₜ)P(Xuₜ)/P(Xuₜ₋₁)

where R denotes a normalization term. This formula is established by hypothesizing as follows:

uniform probability P(θₜ, zuₜ) of that an observed value (Zuₜ) is event information corresponding to identification information obtained at time t, is provided as a generation source of a target (θ) and is assumed to be non-uniform when executing processing for calculating the simultaneous occurrence probability (joint probability); and

target information [Xuₜ] that indicates a state of ser identification information {xuₜ¹, xuₜ², . . . , xuₜⁿ} included in target data at time t and is assumed to be uniform.

In the information processing apparatus of the embodiment of the present invention, furthermore, the information-integration processing unit executes marginalization processing for the probability value P (Xu) when the probability representing a confidence factor corresponding to each target by using a formula: P(xuⁱ)=Σ_{Xu=xui} P(Xu). In the formula, i denotes a denotes a target identifier (tID) for calculating the probability of the confidence factor of the user identifier. In addition, the information-integration processing unit employs the formula to calculate the probability of representing a confidence factor of the user identifier corresponding to each target.

In the information processing apparatus of the embodiment of the present invention, furthermore, the information-integration processing unit executes processing for marginalizing the value of the simultaneous occurrence probability set to candidate data including a target to be deleted to remaining candidate date after deletion of the target, and processing for normalizing the total value of the simultaneous occurrence probability to be set to all the candidate data to 1 (one).

In the information processing apparatus of the embodiment of the present invention, furthermore, when an additional target is generated and added to candidate data, the information-integration processing unit executes processing for allocating states corresponding to the number of users to additional candidate data increased by the addition of the generated target. Then, the information-integration processing unit executes processing for distributing the value of simultaneous occurrence probability set to the existing candidate data to the additional candidate data. Subsequently, the information-integration processing unit executes processing for processing for normalizing the total value of the simultaneous occurrence probability set to all the candidate data to 1 (one).

A second embodiment of the present invention is an information processing method to be executed in an information processing apparatus. The method includes the step of inputting information into an event detecting unit by an information input unit, where the information includes either image information or sound information in actual space. The method also includes the step of allowing the event detecting unit to generate event information by analyzing the information input from the information input unit, where the event information includes estimated identification information of a user present in the actual space. Furthermore, the method includes the step of executing information-integrating processing in which an information-integration processing unit sets probability-distribution data of hypotheses for user identification information and executes processing of identifying the user present in the actual space by updating and selecting the hypothesis on the basis of the event information. Here, the step of information-integrating processing includes a sub-step of executing processing for updating target data on the basis of user identification information included in the event information. In this case, the target data is one that contains user confidence factor information representing which of users corresponds to the target provided as the event occurrence source. Also, the information-integration processing unit executes processing for calculating the user confidence factor by applying a limitation of that the same user does not present simultaneously to the processing for updating the target data.

In the information-processing method of the embodiment of the present invention, the information-integrating step updates the simultaneous occurrence probability (joint probability) of candidate data that allows the targets to corresponding to the respective users on basis of user identification information included in the event information. Then, the information-integrating step applies the updated value of simultaneous occurrence probability to processing for calculating a user confidence factor corresponding to a target and executes such processing.

An embodiment of the present invention is a computer program for allowing an information processing apparatus to execute information processing. The computer program includes the step of inputting information into an event detecting unit by an information input unit, where the information includes either image information or sound information in actual space. The computer program also includes the step of generating event information from the event information by analyzing the information input from the information input unit, where the event information includes estimated identification information of a user present in the actual space. Furthermore, the computer program includes executing information-integrating processing in which an information-integration processing unit sets probability-distribution data of hypotheses for user identification information and executes processing of identifying the user present in the actual space by updating and selecting the hypothesis on the basis of the event information. Here, the step of information-integrating processing includes a step of executing processing for updating target data on the basis of user identification information included in the event information. In this case, the target data is one that contains user confidence factor information representing which of users corresponds to the target provided as the event occurrence source. Also, the information-integration processing unit executes processing for calculating the user confidence factor by applying a limitation of that the same user does not present simultaneously to the processing for updating the target data.

In the computer program of the embodiment of the present invention, the information-integrating step updates the simultaneous occurrence probability (joint probability) of candidate data that allows the targets to corresponding to the respective users on basis of user identification information included in the event information applies the updated value of simultaneous occurrence probability to processing for calculating a user confidence factor corresponding to a target and executes such processing.

The computer program according to the embodiment of the present invention is, for example, a computer program that can be provided to a general-purpose computer system, which can execute various program codes, through a storage medium provided in a computer-readable format or a communication medium. By providing such a program in a computer-readable format, processing corresponding to the program is realized on the computer system.

Other objects, features, and advantages of the present invention will be apparent from a more detailed explanation based on embodiments of the present invention described later and the accompanying drawings. In this specification, a system is a configuration of a logical set of plural apparatuses and is not limited to a system in which apparatuses having individual configurations are provided in an identical housing.

According to any of the embodiments of the present invention, event information including user-identification data is input on the basis of image information or sound information obtained by a camera or a microphone. The update of target data set with plural user confidence factors is executed to generate user identification information.

Simultaneous probability (Joint Probability) of candidate data in which targets correspond to the respective users is updated on the basis of user identification information included in event information. The updated value of the simultaneous probability is then employed to calculate a user confidence factor corresponding to the target. Thus, it is possible to efficiently execute processing for user identification at high precision without causing wrong presumption, such as mistaking different targets for the same user.

### BRIEF DESCRIPTION OF THE DRAWINGS

FIG. 1 is a diagram illustrating an overview of processing executed by an information processing apparatus according to an embodiment of the present invention;

FIG. 2 is a diagram illustrating the structure and processing of the information processing apparatus according to the embodiment;

FIGS. 3A and 3B are diagrams for explaining an example of information generated and inputted to a sound/image-integration processing unit 131 by a sound-event detecting unit 122 or an image-event detecting unit 112;

FIGS. 4A to 4C are diagrams illustrating a basic processing example to which a particle filter is applied;

FIG. 5 is a diagram illustrating the structure of particles set in the processing example;

FIG. 6 is a diagram illustrating the structure of target data of respective targets included in the respective particles;

FIG. 7 is a flowchart for explaining a processing sequence executed by the sound/image-integration processing unit 131;

FIG. 8 is a diagram illustrating details of processing for calculating a target weight [W_{tID}];

FIG. 9 is a diagram illustrating details of processing for calculating a particle weight [W_{pID}];

FIG. 10 is a diagram illustrating details of processing for calculating the particle weight [W_{pID}];

FIG. 11 is a diagram illustrating an example of processing for calculating prior probability P when the number of targets n=2 (target ID (tID=0 to 1)) and the number of registered users k=3 (user ID (uID=0 to 2);

FIG. 12 is a diagram illustrating an example of processing for calculating state transition probability P when the number of targets n=2 (0 to 1)) and the number of registered users k=3 (user ID (0 to 2);

FIG. 13 is a diagram illustrating a transition example of the probability values, or user confidence factors, of user IDs (0 to 2) corresponding target IDs (2, 1, 0) when observation information is observed in order in an example of processing that retains independence between targets;

FIG. 14 is a diagram illustrating the results of marginalization obtained by the processing shown in FIG. 13;

FIG. 15 is a diagram illustrating an example of initial-state setting with a limitation of that “the same user identifier (User ID) is not allocated to plural targets” when the number of targets n=3 (0 to 2) and the number of registered users k=3 (0 to 2).

FIG. 16 is a diagram illustrating an example of analytical processing according to an embodiment of the present invention in which independence between targets is excluded, to which a limitation of that “the same user identifier (User ID) is not allocated to plural targets” is applied;

FIG. 17 is a diagram illustrating the results of marginalization obtained by the processing shown in FIG. 16;

FIG. 18 is a diagram illustrating an example of processing for deleting a state of the presence of at least one xu (user identifier (User ID)) coincided with another one;

FIG. 19 is a diagram illustrating process for deleting a target in a sound/image-integration processing unit 131;

FIG. 20 is a diagram illustrating an example of the processing when a target (tID=0) is deleted from three targets (tID=0, 1, 2);

FIG. 21 is a diagram illustrating processing for generating a new target in a sound/image-integration processing unit 131;

FIG. 22 is a diagram illustrating an example of the processing when a target (tID=3) is newly generated and added to two targets (tID=1, 2); and

FIG. 23 is a flowchart illustrating a processing sequence when analytical processing with exclusion of independence between targets is executed.

### DESCRIPTION OF THE PREFERRED EMBODIMENTS

Hereafter, an information processing apparatus, an information processing method, and a computer program according to embodiments of the present invention will be described in detail with reference to the attached drawings. Here, the embodiments of the present invention are based on the configuration of the invention disclosed in Japanese Patent Application No. 2007-193930, which is a previous application filed by the same applicant as that of the present application. The embodiments of the present invention further improve a presumption performance for identifying a user by excluding independence between targets with respect to the configuration disclosed in Japanese Patent Application No. 2007-193930.

Hereinafter, the embodiments of the present invention will be described in order of the following items:

(1) processing for obtaining user-position information and user-identification information by updating hypothesis based on an event information input; and

(2) exemplary processing with an improvement in presumption performance for user identification by excluding independence between targets.

For the item (1), the embodiment of the present invention is configured in a manner similar to one disclosed in Japanese Patent Application No. 2007-193930. The item (2) is an improving point as an advantage of the embodiment of the present invention.

### (1) Processing for Finding the Position of User and Identifying the User by Renewal of Hypothesis Based on Event Information Input

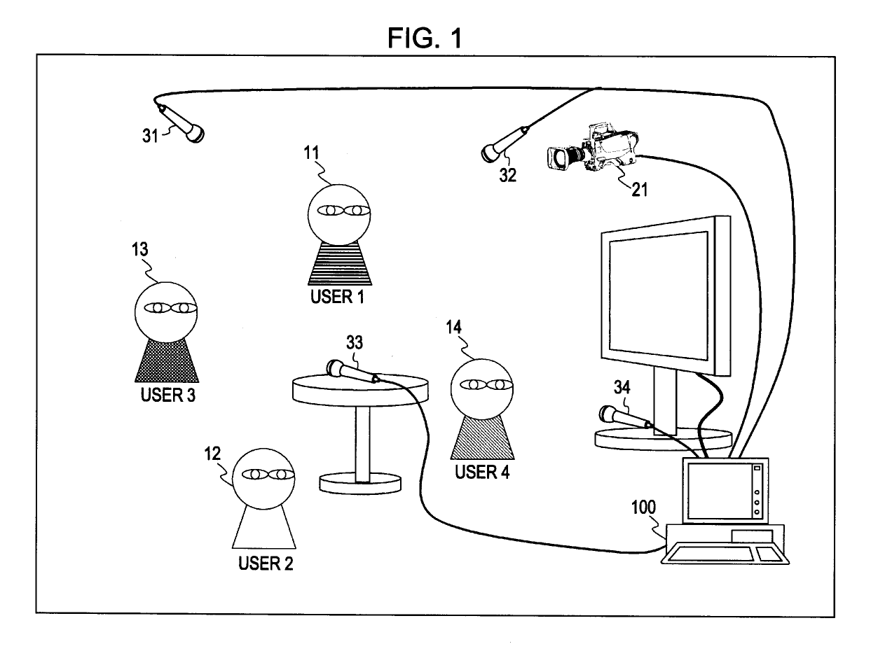

First, an overview of processing executed by an information processing apparatus according to a first embodiment of the present invention will be described with reference to FIG. 1. The information processing apparatus 100 of the present embodiment includes sensors for input of environmental information, such as a camera 21 and a plurality of microphones 31 to 34. The information processing apparatus 100 obtains image information and sound information through these sensors and then analyzes the environmental information on the basis of the input information. Specifically, the information processing apparatus 100 analyzes positions of plural users 1 to 4 denoted by reference numerals 11 to 14 and identification of the users in the positions.

In an example shown in the figure, for example, when the users 1 to 4 (11 to 14) are a father, a mother, a sister, and a brother of a family, the information processing apparatus 100 performs an analysis of image information and sound information input from the camera 21 and the plural microphones 31 to 34. Then, the information processing apparatus 100 identifies positions where the four users 1 to 4 are present and which of the father, the mother, the sister, and the brother the users in the respective positions are. An identification processing results can be used for various kinds of processing, for example, processing for zooming-in of a cameral on a user who spoke and a response from a television to the user who spoke.

Main processing of the information processing apparatus 100 according to this embodiment is user identification processing performed as processing for identifying positions of users and identifying the users on the basis of input information from plural information input units (the camera 21 and the microphones 31 to 34). Processing for using a result of the identification is not specifically limited. Various kinds of uncertain information are included in the image information or the sound information inputted from the camera 21 or the plural microphones 31 to 34. The information processing apparatus 100 according to this embodiment performs probabilistic processing for the uncertain information included in these kinds of input information and performs processing for integrating the input information into information estimated as high in accuracy. Robustness is improved by this estimation processing and a highly accurate analysis is performed.

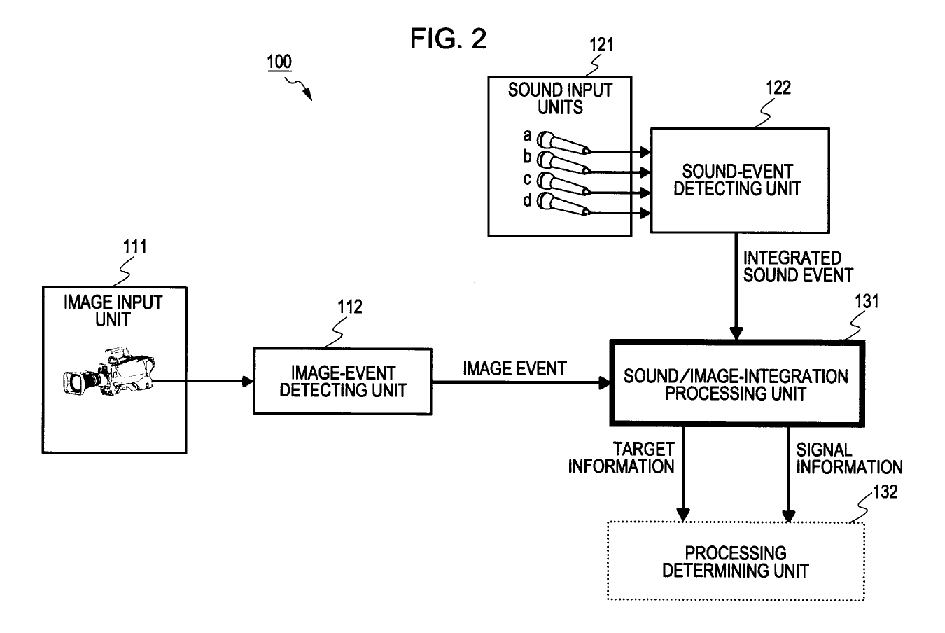

An example of the structure of the information processing apparatus 100 is shown in FIG. 2. The information processing apparatus 100 has an image input unit (a camera) 111 and plural sound input unit (microphones) 121a to 121d as input devices. Image information is inputted from the image input unit (the camera) 111 and sound information is inputted from the sound input units (the microphones) 121. The information processing apparatus 100 performs an analysis on the basis of these kinds of input information. The respective plural sound input units (microphones) 121a to 121d are arranged in various positions as shown in FIG. 1.

The sound information inputted from the plural microphones 121a to 121d is inputted to a sound/image-integration processing unit 131 via a sound-event detecting unit 122. The sound-event detecting unit 122 analyzes and integrates the sound information inputted from the plural sound inputting units (microphones) 121a to 121d arranged in plural different positions. Specifically, the sound-event detecting unit 122 generates, on the basis of the sound information inputted from the sound input units (the microphones) 121a to 121d, user identification information indicating a position of generated sound and which of the users generated the sound and inputs the user identification information to the sound/image-integration processing unit 131.

Specific processing executed by the information processing apparatus 100 is, for example, processing for identifying which of the users 1 to 4 spoke in which position in an environment in which plural users are present as shown in FIG. 1. In other words, it is processing for performing user position and user identification and processing for specifying an event occurrence source such as a person who uttered voice.

The sound-event detecting unit 122 analyzes the sound information inputted from the plural sound input units (microphones) 121a to 121d arranged in the plural different positions and generates position information of sound generation sources as probability distribution data. Specifically, the sound-event detecting unit 122 generates expected values and variance data N(mₑ, σₑ) concerning sound source directions. The sound-event detecting unit 122 generates user identification information on the basis of comparison processing with characteristic information of user voices registered in advance. The identification information is also generated as a probabilistic estimated value. Characteristic information concerning voices of plural users, which should be verified, is registered in advance in the sound-event detecting unit 122. The sound-event detecting unit 122 executes comparison processing of input sound and registered sound, performs processing for judging which user's voice the input sound is with a high probability, and calculates posterior probabilities or scores for all the registered users.

In this way, the sound-event detecting unit 122 analyzes the sound information inputted from the plural sound input units (microphones) 121a to 121d arranged in the plural different positions, generates integrated sound event information from the probability distribution data generated from the position information of sound generation sources and the user identification information including the probabilistic estimated value, and inputs the integrated sound event information to the sound/image-integration processing unit 131.

On the other hand, the image information inputted from the image input unit (the camera) 111 is inputted to the sound/image-integration processing unit 131 via the image-event detecting unit 112. The image-event detecting unit 112 analyzes the image information inputted from the image input unit (the camera) 111, extracts faces of people included in the image, and generates position information of the faces as probability distribution data. Specifically, the image-event detecting unit 112 generates expected values and variance data N(mₑ, σₑ) concerning positions and directions of the faces. The image-event detecting unit 112 generates user identification information on the basis of comparison processing with characteristic information of user faces registered in advance. The identification information is also generated as a probabilistic estimated value. Characteristic information concerning faces of plural users, which should be verified, is registered in advance in the image-event detecting unit 112. The image-event detecting unit 112 executes comparison processing of characteristic information of an image of a face area extracted from an input image and the registered characteristic information of face images. Then, image-event detecting unit 112 executes processing for judging which user's face the image of the face area is with a high probability, followed by calculating posterior probabilities or scores for all the registered users.

A technique known in the past is applied to the sound identification, face detection, and face identification processing executed in the sound-event detecting unit 122 and the image-event detecting unit 112. For example, the techniques disclosed in the following documents can be applied as the face detection and face identification processing:

Kotaro Sabe and Ken-ichi Hidai, “Learning of an Actual Time Arbitrary Posture and Face Detector Using a Pixel Difference Characteristic”,

Tenth Image Sensing Symposium Lecture Proceedings, pp. 547 to 552, 2004; and

Japanese Unexamined Patent Application Publication No. 2004-302644 in titled “Face Identification Apparatus, Face Identification Method, Recording Medium, and Robot Apparatus”.

The sound/image-integration processing unit 131 executes processing on the basis of the input information from the sound-event detecting unit 122 or the image-event detecting unit 112. That is, the unit 131 determines where the plural users are present, respectively, who are the users, and who uttered a signal such as sound. This processing will be described in detail later. The sound/image-integration processing unit 131 outputs the following items (a) and (b) to a processing determining unit 132 on the basis of the input information from the sound-event detecting unit 122 or the image-event detecting unit 112:

(a) [target information] as estimation information indicating where the plural users are present, respectively, and who are the users; and

(b) [signal information] indicating an event occurrence source such as a user who spoke.

The processing determining unit 132 receives results of these kinds of identification processing and executes processing using the identification processing results. For example, the processing determining unit 132 performs processing such as zooming-in of a camera on a user who spoke and a response from a television to the user who spoke.

As described above, the sound-event detecting unit 122 generates position information of sound generation sources as probability distribution data. Specifically, the sound-event detecting unit 122 generates expected values and variance data N(mₑ, σₑ) concerning sound source directions. The sound-event detecting unit 122 generates user identification information on the basis of comparison processing with characteristic information of user voices registered in advance and inputs the user identification information to the sound/image-integration processing unit 131. The image-event detecting unit 112 extracts faces of people included in an image and generates position information of the faces as probability distribution data. Specifically, the image-event detecting unit 112 generates expected values and variance data N(mₑ, σₑ) concerning positions and directions of the faces. The image-event detecting unit 112 generates user identification information on the basis of comparison processing with characteristic information of user faces registered in advance and inputs the user identification information to the sound/image-integration processing unit 131.

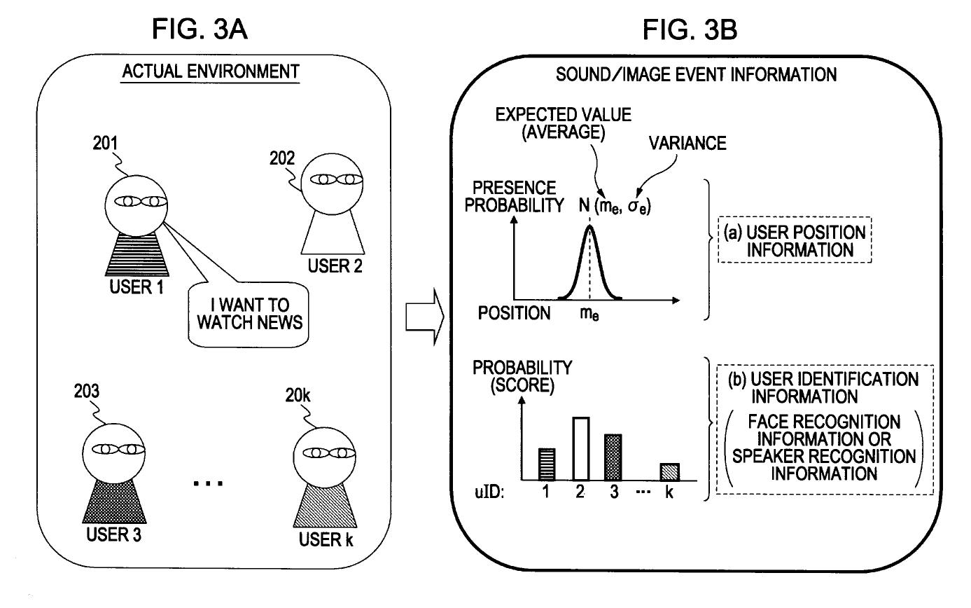

An example of information generated and inputted to the sound/image-integration processing unit 131 by the sound-event detecting unit 122 or the image-event detecting unit 112 will be described with reference to FIGS. 3A and 3B. FIG. 3A shows an example of an actual environment including a camera and microphones same as the actual environment explained with reference to FIG. 1. Plural users 1 to k (201 to 20k) are present in the actual environment. In this environment, when a certain user speaks, sound is inputted through a microphone. The camera is continuously photographing images.

The information generated and inputted to the sound/image-integration processing unit 131 by the sound-event detecting unit 122 and the image-event detecting unit 112 is basically the same information and includes two kinds of information shown in FIG. 3B. Namely, the information includes:

(a) user position information; and

(b) user identification information (face identification information or speaker identification information).

These two kinds of information are generated every event. When sound information is inputted from the sound input units (the microphones) 121a to 121d, the sound-event detecting unit 122 generates (a) user position information and (b) user identification information on the basis of the sound information and inputs the information to the sound/image-integration processing unit 131. The image-event detecting unit 112 generates, for example, at a fixed frame interval set in advance, (a) user position information and (b) user identification information on the basis of image information inputted from the image input unit (the camera) 111 and inputs the information to the sound/image-integration processing unit 131. In this example, one camera is set as the image input unit (the camera) 111. Images of plural users are photographed by the one camera. In this case, the image-event detecting unit 112 generates (a) user position information and (b) user identification information for respective plural faces included in one image and inputs the information to the sound/image-integration processing unit 131.

Processing by the sound-event detecting unit 122 for generating

(a) user position information and

(b) user identification information (speaker identification information) on the basis of sound information inputted from the sound input units (the microphones) 121a to 121d will be described.

Processing for generating (a) user position information by the sound-event detecting unit 122. The sound-event detecting unit 122 generates, on the basis of sound information inputted from the sound input units (the microphones) 121a to 121d, estimation information concerning a position of a user who utters an analyzed voice, i.e., a [speaker]. In other words, the sound-event detecting unit 122 generates positions where the speaker is estimated to be present as Gaussian distribution (normal distribution) data N(mₑ, σₑ) including an expected value (average) [mₑ] and variance information [σₑ]

Processing for generating (b) user identification information (speaker identification information) by the sound-event detecting unit 122

The sound-event detecting unit 122 estimates who a speaker is on the basis of sound information inputted from the sound input units (the microphones) 121a to 121d by performing comparison processing of input sound and characteristic information of voices of the users 1 to k registered in advance. Specifically, the sound-event detecting unit 122 calculates probabilities that the speaker is the respective users 1 to k. Values calculated by the calculation are set as (b) user identification information (speaker identification information). For example, the sound-event detecting unit 122 generates data set with probabilities that the speaker is the respective users and then sets the data as (b) user identification information (speaker identification information). In this case, the generation of such data is attained by executing processing for allocating a highest score to a user having a registered sound characteristic closest to a characteristic of the input sound and allocating a lowest score (e.g., 0) to a user having a sound characteristic most different from the characteristic of the input sound,

Now, on the basis of image information inputted from the image input unit (the camera) 111, processing for generating the following two kinds of information will be described:

(a) user position information and

(b) user identification information (face identification information).

### Processing for Generating (a) User Position Information by the Image-Event Detecting Unit 112

The image-event detecting unit 112 generates estimation information concerning positions of faces for respective faces included in image information inputted from the image input unit (the camera) 111. In other words, the image-event detecting unit 112 generates positions where faces detected from an image are estimated to be present as Gaussian distribution (normal distribution) data N(mₑ, σₑ) including an expected value (average) [mₑ] and variance information [σₑ].

Processing for generating (b) user identification information (face identification information) by the image-event detecting unit 112. The image-event detecting unit 112 detects, on the basis of image information inputted from the image input unit (the camera) 111, faces included in the image information and estimates whose face the respective faces are by performing comparison processing of the input image information and characteristic information of faces of the users 1 to k registered in advance. Specifically, the image-event detecting unit 112 calculates probabilities that the extracted respective faces are the respective users 1 to k. Values calculated by the calculation are set as (b) user identification information (face identification information). For example, the image-event detecting unit 112 generates data set with probabilities that the faces are the respective users by performing processing for allocating a highest score to a user having a registered face characteristic closest to a characteristic of a face included in an input image and allocating a lowest score (e.g., 0) to a user having a face characteristic most different from the characteristic of the face included in the input image and sets the data as (b) user identification information (face identification information).

When plural faces are detected from a photographed image of the camera, the image-event detecting unit 112 generates (a) user position information and (b) user identification information (face identification information) according to the respective detected faces and inputs the information to the sound/image-integration processing unit 131.

In this example, one camera is used as the image input unit 111. However, photographed images of plural cameras may be used. In that case, the image-event detecting unit 112 generates (a) user position information and (b) user identification information (face identification information) for respective faces included in the respective photographed images of the respective cameras and inputs the information to the sound/image-integration processing unit 131.

Processing executed by the sound/image-integration processing unit 131 will be described.

As described above, the sound/image integration processing unit 131 is sequentially inputted with the two kinds of information shown in FIG. 3B, i.e., (a) user position information and (b) user identification information (face identification information or speaker identification information) from the sound-event detecting unit 122 or the image-event detecting unit 112. As input timing for these kinds of information, various settings are possible. For example, in a possible setting, the sound-event detecting unit 122 generates and inputs the respective kinds of information (a) and (b) as sound event information when new sound is inputted and the image-event detecting unit 112 generates and inputs the respective kinds of information (a) and (b) as image event information in fixed frame period units.

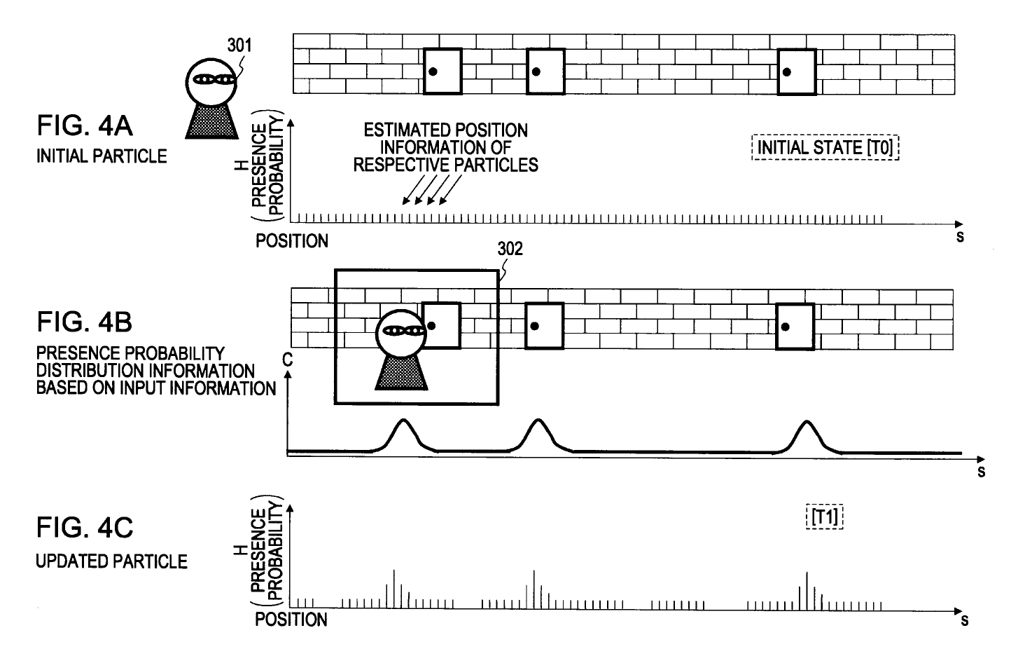

Processing executed by the sound/image-integration processing unit 131 will be described with reference to FIGS. 4A to 4C and subsequent figures.

The sound/image-integration processing unit 131 sets probability distribution data of hypotheses concerning position and identification information of users and updates the hypotheses on the basis of input information to thereby perform processing for leaving only more likely hypotheses. As a method of this processing, the sound/image-integration processing unit 131 executes processing to which a particle filter is applied.

The processing to which the particle filter is applied is processing for setting a large number of particles corresponding to various hypotheses, in this example, hypotheses concerning positions and identities of users and increasing weights of more likely particles on the basis of the two kinds of information shown in FIG. 3B, i.e., (a) user position information and (b) user identification information (face identification information or speaker identification information) inputted from the sound-event detecting unit 122 or the image-event detecting unit 112.

Referring now to FIGS. 4A to 4C, an example of basic processing to which the particle filter is applied will be described. For example, the example shown in FIGS. 4A to 4C indicates an example of processing for estimating a presence position corresponding to a certain user using the particle filter. The example shown in FIGS. 4A to 4C is processing for estimating a position where a user 301 is present in a one-dimensional area on a certain straight line.

An initial hypothesis (H) is uniform particle distribution data as shown in FIG. 4A. Then, image data 302 is acquired and presence probability distribution data of the user 301 based on an acquired image is acquired as data shown in FIG. 4B. The particle distribution data shown in FIG. 4A is updated on the basis of the probability distribution data based on the acquired image. Updated hypothesis probability distribution data shown in FIG. 4C is obtained. Such processing is repeatedly executed on the basis of input information to obtain more likely position information of the user.

Details of the processing performed by using the particle filter are described in, for example, [D. Schulz, D. Fox, and J. Hightower, People Tracking with Anonymous and ID-sensors Using Rao-Blackwellised Particle Filters, Proc. of the International Joint Conference on Artificial Intelligence (IJCAI-03)].

The processing example shown in FIGS. 4A to 4C will be described as a processing example in which input information is only image data only for a presence position of the user 301. Respective particles have information concerning only the presence position of the user 301.

On the other hand, the processing according to this embodiment is processing for discriminating positions of plural users and who the plural users are on the basis of the two kinds of information shown in FIG. 3B, i.e., (a) user position information and (b) user identification information (face identification information or speaker identification information) inputted from the sound-event detecting unit 122 or the image-event detecting unit 112.

Therefore, in the processing to which the particle filter is applied in this embodiment, the sound/image-integration processing unit 131 sets a large number of particles corresponding to assume concerning positions of users and who the users are and updates particles on the basis of the two kinds of information shown in FIG. 3B inputted from the sound-event detecting unit 122 or the image-event detecting unit 112.

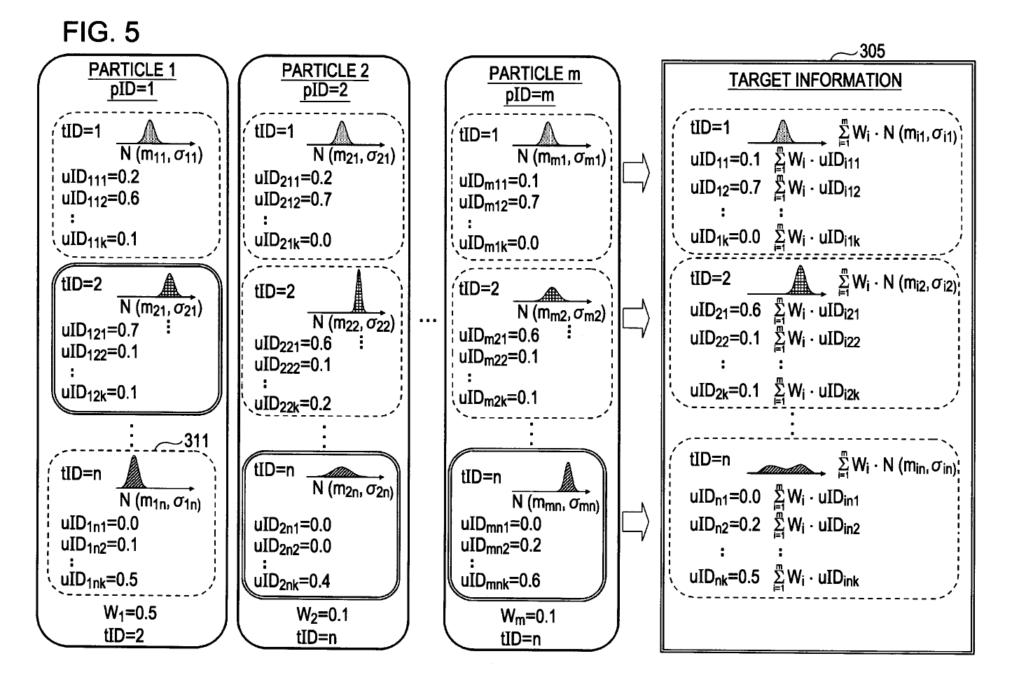

Referring now to FIG. 5, the structure of particles set in this processing example will be described.

The sound/image-integration processing unit 131 has m (a number set in advance) particles. In other words, these are particles 1 to m shown in FIG. 5. Particle IDs (pID=1 to m) as identifiers are set for the respective particles.

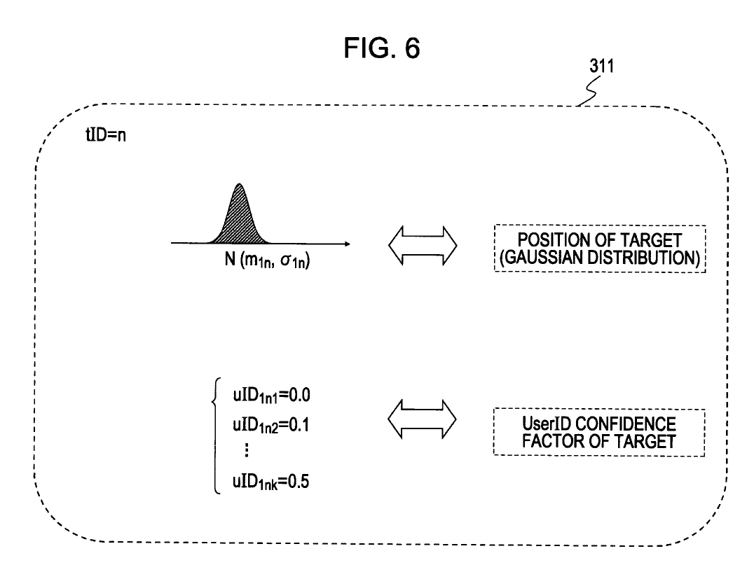

Plural targets corresponding to virtual objects corresponding to positions and objects to be identified are set for the respective particles. In this example, for example, plural targets corresponding to virtual users equal to or lager in number than a number estimated as being present in an actual space are set for the respective particles. In the respective m particles, data equivalent to the number of targets are held in target units. In the example shown in FIG. 5, n targets are included in one particle. The structure of target data of the respective targets included in the respective particles is shown in FIG. 6.

The respective target data included in the respective particles will be described with reference to FIG. 6. FIG. 6 is the structure of target data of one target (target ID: tID=n) 311 included in the particle 1 (pID=1) shown in FIG. 5. The target data of the target 311 includes the following data as shown in FIG. 6:

(a) a probability distribution [Gaussian distribution: N(m₁ₙ, σ₁ₙ)] of presence positions corresponding to the respective targets; and

(b) user confidence factor information (uID) indicating who the respective targets are, i.e., uID₁ₙ₁=0.0, uID₁ₙ₂=0.1, . . . and uID₁ₙₖ=0.5.

By the way, (1n) of [m₁ₙ, σ₁ₙ] in the Gaussian distribution N(m₁ₙ, σ₁ₙ) described in (a) means a Gaussian distribution as a presence probability distribution corresponding to a target ID: tID=n in a particle ID: pID=1.

In addition, (1n1) included in [uID₁ₙ₁] in the user confidence factor information (uID) described in (b) means a probability that a user with a target ID: tID=n in a particle ID: pID=1 is a user 1. In other words, data with a target ID=n means that a probability that the user is a user 1 is 0.0, a probability that the user is a user 2 is 0.1, . . . and a probability that the user is a user k is 0.5.

Referring back to FIG. 5, the explanation about the particles set by the sound/image-integration processing unit 131 will be continued. As shown in FIG. 5, the sound/image-integration processing unit 131 sets m (the number set in advance) particles (pID=1 to m). The respective particles have, for respective targets (tID=1 to n) estimated as being present in the actual space, target data of (a) a probability distribution [Gaussian distribution: N (m, σ)] of presence positions corresponding to the respective targets; and (b) user confidence factor information (uID) indicating who the respective targets are.

The sound/image-integration processing unit 131 is inputted with the event information shown in FIG. 3B, i.e., (a) user position information and (b) user identification information (face identification information or speaker identification information) from the sound-event detecting unit 122 or the image-event detecting unit 112 and performs processing for updating the m particles (pID=1 to m).

The sound/image-integration processing unit 131 executes the processing for updating the particles, generates (a) target information as estimation information indicating where plural users are present, respectively, and who the users are and (b) signal information indicating an event occurrence source such as a user who spoke, and outputs the information to the processing determining unit 132.

As shown in target information 305 at a right end in FIG. 5, the target information is generated as weighted sum data of data corresponding to the respective targets (tID=1 to n) included in the respective particles (pID=1 to m). Weights of the respective particles are described later.

The target information 305 is information indicating (a) presence positions of targets (tID=1 to n) corresponding to virtual users set in advance by the sound/image-integration processing unit 131 and (b) who the targets are (which one of uID1 to uIDk the targets are). The target information is sequentially updated according to update of the particles. For example, when the users 1 to k do not move in the actual environment, the respective users 1 to k converge as data corresponding to k targets selected out of the n targets (tID=1 to n).

For example, user confidence factor information (uID) included in data of a target 1 (tID=1) at the top in the target information 305 shown in FIG. 5 has a highest probability concerning the user 2 (uID₁₂=0.7). Therefore, the data of the target 1 (tID=1) is estimated as corresponding to the user 2. (12) in (uID₁₂) in the data [uID₁₂=0.7] indicating the user confidence factor information (uID) indicates a probability corresponding to the user confidence factor information (uID) of the user 2 with the target ID=1.

The data of the target 1 (tID=1) at the top in the target information 305 corresponds to the user 2 with a highest probability. A presence position of the user 2 is estimated as being within a range indicated by presence probability distribution data included in the data of the target 1 (tID=1) at the top in the target information 305.

In this way, the target information 305 indicates, concerning the respective targets (tID=1 to n) initially set as virtual objects (virtual users), respective kinds of information of (a) presence positions of the targets and (b) who the targets are (which one of uIDI to UIDk the targets are). Therefore, respective k pieces of target information of the respective targets (tID=1 to n) converge to correspond to the users 1 to k when the users do not move.

When the number of targets (tID=1 to n) is larger than the number of users k, there are targets that correspond to no user. For example, in a target (tID=n) at the bottom in the target information 305, the user confidence factor information (uID) is 0.5 at the maximum and the presence probability distribution data does not have a large peak. Such data is judged as not data corresponding to a specific user. Processing for deleting such a target may be performed. The processing for deleting a target is described later.

As explained above, the sound/image-integration processing unit 131 executes the processing for updating the particles on the basis of input information, generates (a) target information as estimation information indicating where plural users are present, respectively, and who the users are and (b) signal information indicating an event occurrence source such as a user who spoke, and outputs the information to the processing determining unit 132.

The target information is the information explained with reference to the target information 305 shown in FIG. 5.

Besides the target information, the sound/image-integration processing unit 131 generates signal information indicating an event occurrence source such as a user who spoke and outputs the signal information. The signal information indicating the event occurrence source is, concerning a sound event, data indicating who spoke, i.e., a speaker and, concerning an image event, data indicating whose face a face included in an image is. In this example, as a result, the signal information in the case of the image event coincides with signal information obtained from the user confidence factor information (uID) of the target information.

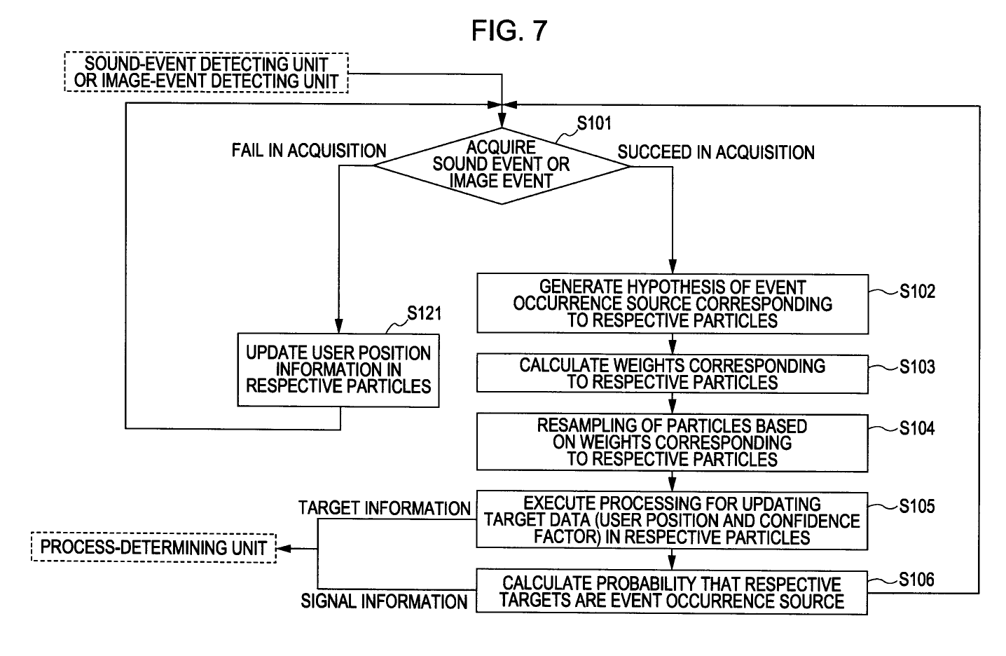

As described above, the sound/image-integration processing unit 131 is inputted with the event information shown in FIG. 3B, i.e., user position information and user identification information (face identification information or speaker identification information) from the sound-event detecting unit 122 or the image-event detecting unit 112, generates (a) target information as estimation information indicating where plural users are present, respectively, and who the users are and (b) signal information indicating an event occurrence source such as a user who spoke, and outputs the information to the processing determining unit 132. This processing will be described below with reference to FIG. 7 and subsequent figures.

FIG. 7 is a flowchart for explaining a processing sequence executed by the sound/image-integration processing unit 131. First, in step S101, the sound/image-integration processing unit 131 is inputted with the event information shown in FIG. 3B, i.e., user position information and user identification information (face identification information or speaker identification information) from the sound-event detecting unit 122 or the image-event detecting unit 112.

When succeeding in acquisition of the event information, the sound/image-integration processing unit 131 proceeds to step S102. When failing in acquisition of the event information, the sound/image-integration processing unit 131 proceeds to step S121. Processing in step S121 will be described later. The latter part explains a process of Step S121.

When succeeding in acquisition of the event information, the sound/image-integration processing unit 131 performs particle update processing based on the input information in step S102 and subsequent steps. Before the particle update processing, in step S102, the sound/image-integration processing unit 131 sets hypotheses of an event occurrence source in the respective m particles (pID=1 to m) shown in FIG. 5. The event occurrence source is, for example, in the case of a sound event, a user who spoke and, in the case of an image event, a user who has an extracted face.

In the example shown in FIG. 5, hypothesis data (tID=xx) of an event occurrence source is shown at the bottom of the respective particles. In the example shown in FIG. 5, hypotheses indicating which of the targets 1 to n the event occurrence source is are set for the respective particles in such a manner as

tID=2 for the particle 1 (pID=1)

tID=n for the particle 2 (pID2), . . . , and

tID=n for the particle m (pID=m).

In the example shown in FIG. 5, target data of the event occurrence source set as the hypotheses are surrounded by double lines and indicated for the respective particles.

The setting of hypotheses of an event occurrence source is executed every time the particle update processing based on an input event is performed.

In other words, the sound/image-integration processing unit 131 sets hypotheses of an event occurrence source for the respective particles 1 to m. Under the hypotheses, the sound/image-integration processing unit 131 is inputted with the event information shown in FIG. 3B, i.e., (a) user position information and (b) user identification information (face identification information or speaker identification information) as an event from the sound-event detecting unit 122 or the image-event detecting unit 112 and performs processing for updating the m particles (pID=1 to m)

When the particle update processing is performed, the hypotheses of an event occurrence source set for the respective particles 1 to m are reset and new hypotheses are set for the respective particles 1 to m. As a form of setting hypotheses, it is possible to adopt any one of methods of

(1) random setting and

(2) setting according to an internal model of the sound/image-integration processing unit 131.

The number of particles m is set larger than the number n of targets. Therefore, plural particles are set in hypotheses in which an identical target is an event occurrence source. For example, when the number of targets n is 10, for example, processing with the number of particles m set to about 100 to 1000 is performed.

A specific processing example of the processing for (2) setting hypotheses according to an internal model of the sound/image-integration processing unit 131 will be described.

First, the sound/image-integration processing unit 131 calculates weights [W_{tID}] of the respective targets by comparing the event information acquired from the sound-event detecting unit 122 or the image-event detecting unit 112, i.e., the two kinds of information shown in FIG. 3B, i.e., (a) user position information and (b) user identification information (face identification information or speaker identification information) and data of targets included in particles held by the sound/image-integration processing unit 131. The sound/image-integration processing unit 131 sets hypotheses of an event occurrence source for the respective particles (pID=1 to m) on the basis of the calculated weights [W_{tID}] of the respective targets. The specific processing example will be described below.

In an initial state, hypotheses of an event occurrence source set for the respective particles (pID=1 to m) are set equal. In other words, when m particles (pID=1 to m) having the n targets (tID=1 to n) are set, initial hypothesis targets (tID=1 to n) of an event occurrence source set for the respective particles (pID=1 to m) are set to be equally allocated in such a manner that m/n particles are particles having the target 1 (tID=1) as an event occurrence source, m/n particles are particles having the target 2 (tID=2) as an event occurrence source, . . . , and m/n particles are particles having the target n (tID=n) as an event occurrence source.

In step S101 shown in FIG. 7, the sound/image-integration processing unit 131 acquires the event information, i.e., the two kinds of information shown in FIG. 3B, i.e., (a) user position information and (b) user identification information (face identification information or speaker identification information) from the sound-event detecting unit 122 or the image-event detecting unit 112. When succeeding in acquisition of the event information, in step S102, the sound/image-integration processing unit 131 sets hypothesis targets (tID=1 to n) of an event occurrence source for the respective m particles (pID=1 to m).

Details of the setting of hypothesis target corresponding to the particles in step S102 are explained. First, the sound/image-integration processing unit 131 compares the event information inputted in step S101 and the data of the targets included in the particles held by the sound/image-integration processing unit 131 and calculates target weights [W_{tID}] of the respective targets using a result of the comparison.

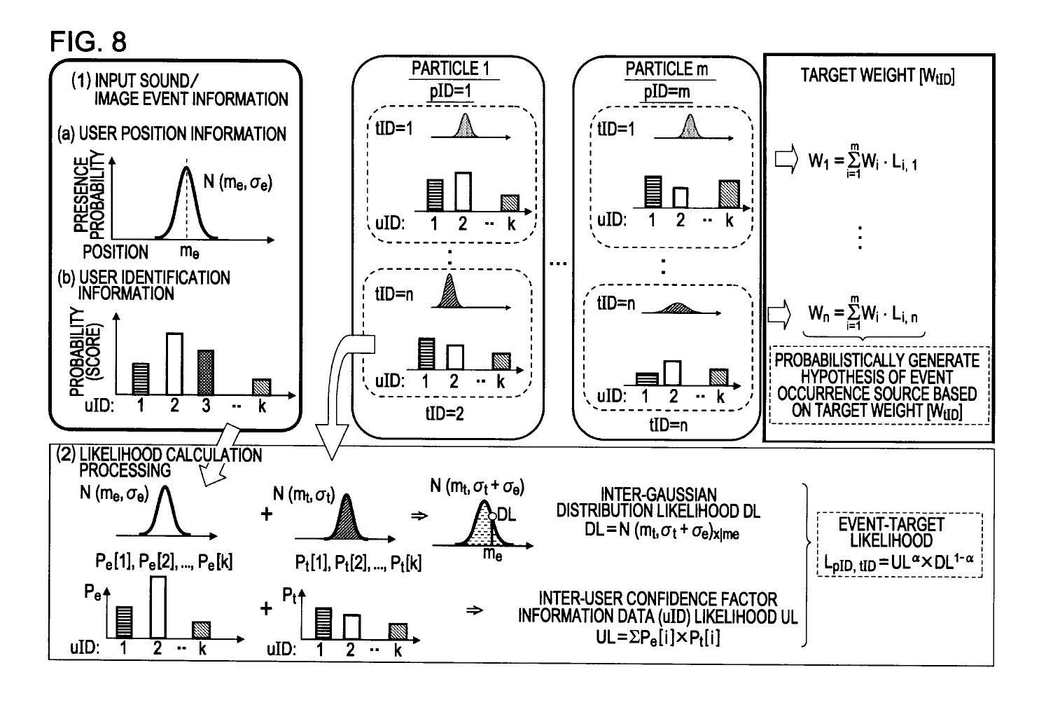

Details of the processing for calculating target weights [W_{tID}] are explained with reference to FIG. 8. The calculation of target weights is executed as processing for calculating n target weights corresponding to the respective targets 1 to n set for the respective particles as shown at a right end in FIG. 8. In calculating the n target weights, first, the sound/image-integration processing unit 131 calculates likelihoods as indication values of similarities between input event information shown in (1) in FIG. 8, i.e., the event information inputted to the sound/image-integration processing unit 131 from the sound-event detecting unit 122 or the image-event detecting unit 112 and respective target data of the respective particles.

An example of likelihood calculation processing shown in (2) in FIG. 8 is an example of calculation of an event-target likelihood by comparison of the input event information (1) and one target data (tID=n) of the particle 1.

In FIG. 8, an example of comparison with one target data is shown. However, the same likelihood calculation processing is executed on the respective target data of the respective particles.

The likelihood calculation processing (2) shown at the bottom of FIG. 8 will be described.

As shown in (2) in FIG. 8, as the likelihood calculation processing, first, the sound/image-integration processing unit 131 individually calculates

(a) an inter-Gaussian distribution likelihood [DL] as similarity data between an event concerning user position information and target data and

(b) an inter-user confidence factor information (uID) likelihood [UL] as similarity data between an event concerning user identification information (face identification information or speaker identification information) and the target data.

First, processing for calculating (a) the inter-Gaussian distribution likelihood [DL] as similarity data between an event concerning user position information and target data will be described.

A Gaussian distribution corresponding to user position information in the input event information shown in (1) in FIG. 8 is represented as N(mₑ, σₑ). A Gaussian distribution corresponding to user position information of a certain target included in a certain particle of the internal model held by the sound/image-integration processing unit 131 is represented as N(mₜ, σₜ). In the example shown in FIG. 8, a Gaussian distribution included in target data of the target n (tID=n) of the particle 1 (pID=1) is represented as N (mₜ, σₜ).

An inter-Gaussian distribution likelihood [DL] as an index for judging a similarity between the Gaussian distributions of these two data is calculated by the following equation:

DL=N(mₜ,σₜ+σₑ)x|mₑ

The equation is an equation for calculating a value of a position of x=mₑ in a Gaussian distribution with a variance .σₜ+σₑ in the center mₜ.

Processing for calculating (b) the inter-user confidence factor information (uID) likelihood [UL] as similarity data between an event concerning user identification information (face identification information or speaker identification information) and the target data will be described.

Values (scores) of confidence factors of the respective users 1 to k of the user confidence factor information (uID) in the input event information shown in (1) in FIG. 8 are represented as Pₑ [i]. “i” is a variable corresponding to user identifiers 1 to k.

Values (scores) of confidence factors of the respective users 1 to k of user confidence factor information (uID) of a certain target included in a certain particle of the internal model held by the sound/image-integration processing unit 131 are represented as Pₜ[i]. In the example shown in FIG. 8, values (scores) of confidence factors of the respective users 1 to k of the user confidence factor information (uID) included in the target data of the target n (tID=n) of the particle 1 (pID=1) are represented as Pₜ[i].

An inter-user confidence factor information (uID) likelihood [UL] as an index for judging a similarity between the user confidence factor information (uID) of these two data is calculated by the following equation:

UL=ΣPₑ[i]×Pₜ[i]

The equation is an equation for calculating a sum of products of values (scores) of confidence factors of respective corresponding users included in the user confidence factor information (uID) of the two data. A value of the sum is the inter-user confidence factor information (uID) likelihood [UL].

Alternatively, it is also possible that a maximum of the respective products, i.e., a value UL=arg max(Pₑ[i]x Pₜ[i]) is calculated as the inter-user confidence factor information (uID) likelihood [UL] and this value is used as the inter-user confidence factor information (uID) likelihood [UL].

An event-target likelihood [L_{pID, tiD}] as an index of a similarity between the input event information and one target (tID) included in a certain particle (pID) is calculated by using the two likelihoods, i.e., the inter-Gaussian distribution likelihood [DL] and the inter-user confidence factor information (uID) likelihood [UL]. In other words, the event-target likelihood [L_{pID, tiD}] is calculated by the following equation by using a weight α (α=0 to 1):

[L_{pID,tiD}]=UL^{α}×DL^{1-α}

where α=0 to 1.

The event-target likelihood [L_{pID, tiD}] is calculated for the respective targets of the respective particles. Target weights [W_{tID}] of the respective targets are calculated on the basis of the event-target likelihood [L_{pID, tiD}].

The weight [α] applied to the calculation of the event-target likelihood [L_{pID, tiD}] may be a value fixed in advance or may be set to be changed according to an input event. It is also possible that, for example, in the case in which the input event is an image, for example, when face detection is successful and position information can be acquired but face identification is failed, α is set to 0, the inter-user confidence factor information (uID) likelihood [UL] is set to 1, the event-target likelihood [L_{pID, tiD}] is calculated depending only on the inter-Gaussian likelihood [DL], and a target weight [W_{tID}] depending only on the inter-Gaussian likelihood [DL] is calculated.

It is also possible that, for example, in the case in which the input event is sound, for example, when speaker identification is successful and speaker information can be acquired but acquisition of position information is failed, α is set to 0, the inter-Gaussian distribution likelihood [DL] is set to 1, the event-target likelihood [L_{pID, tiD}] is calculated depending only on the inter-user confidence factor information (uID) likelihood [UL], and the target weight [W_{tID}] depending only on the inter-user confidence factor information (uID) likelihood [UL] is calculated.

A formula for calculating the target weight [W_{tID}] based on the event-target likelihood [L_{pID, tiD}] is as follows:

$${W}_{tID} = {\sum }_{pID}^{m} {W}_{pID} {L}_{pID , tID} \qquad [ Equation 1 ]$$

In the formula, [W_{pID}] is a particle weight set for the respective particles. Processing for calculating the particle weight [W_{pID}] will be described later. In an initial state, as the particle weight [W_{pID}], a uniform value is set for all the particles (pID=1 to m).

The processing in step S101 in the flow shown in FIG. 7, i.e., the generation of event occurrence source hypothesis corresponding to the respective particles is executed on the basis of the target weight [W_{tID}] calculated on the basis of the event-target likelihood [L_{pID, tiD}]. As the target weight [W_{tID}], n data corresponding to the target 1 to n (tID=1 to n) set for the particles are calculated.

Event occurrence source hypothesis targets corresponding to the respective m particles (pID=1 to m) are set to be allocated according to a ratio of the target weight [W_{tID}].

For example, when n is 4 and the target weight [W_{tID}] calculated according to the targets 1 to 4 (tID=1 to 4) is as follows:

the target 1: target weight=3;

the target 2: target weight=2;

the target 3: target weight=1; and

the target 4: target weight=5, the event occurrence source hypothesis targets of the m particles are set as follows:

30% in the m particles is an event occurrence source hypothesis target 1; 20% in the m particles is an event occurrence source hypothesis target 2; 10% in the m particles is an event occurrence source hypothesis target 3; and 50% in the m particles is an event occurrence source hypothesis target 4. In other words, event occurrence source hypothesis targets set for the particles are distributed according to a ratio of weights of the targets.

After setting the hypotheses, the sound/image-integration processing unit 131 proceeds to step S103 of the flow shown in FIG. 7. In step 5103, the sound/image-integration processing unit 131 calculates weighs corresponding to the respective particles, i.e., particle weights [W_{pID}]. As the particle weights [W_{pID}], as described above, a uniform value is initially set for the respective particles but is updated according to an event input.

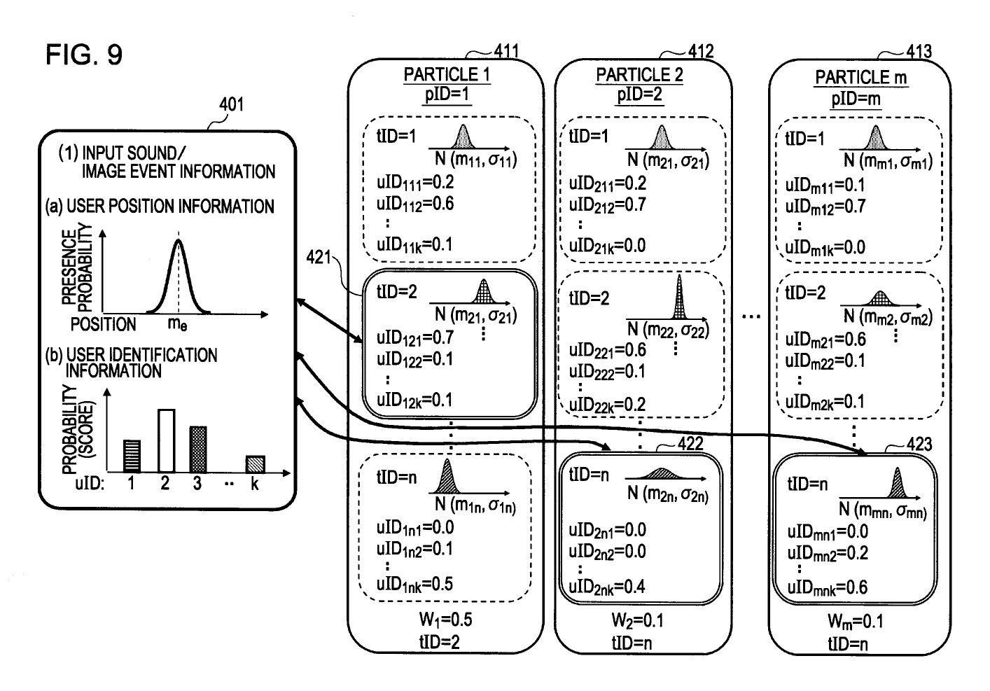

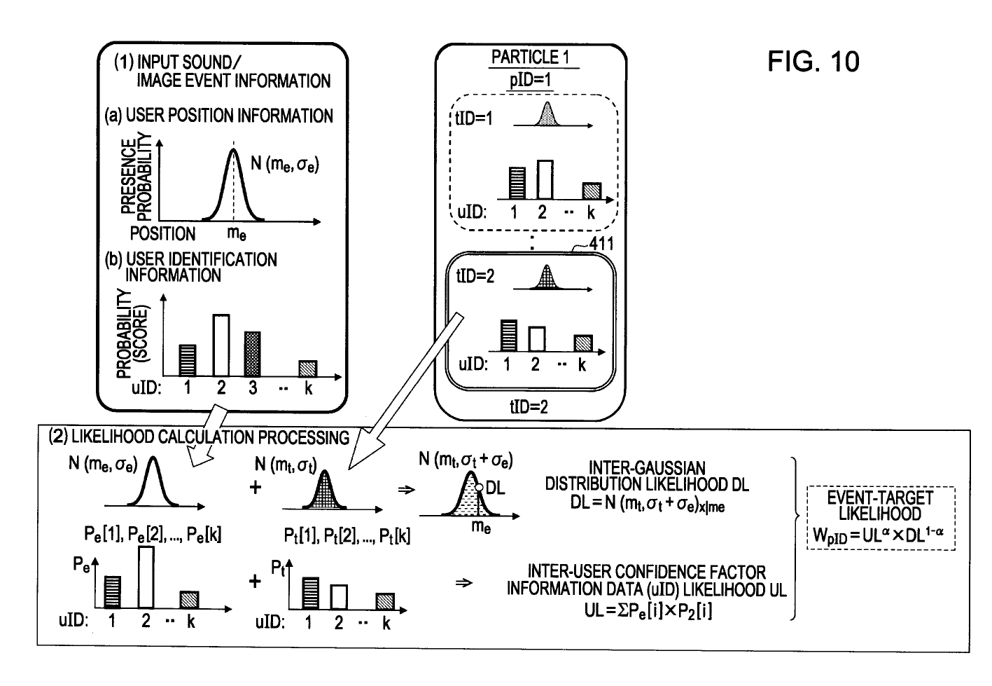

Details of processing for calculating a particle weight [W_{pID}] are explained with reference to FIGS. 9 and 10. The particle weight [W_{pID}] are equivalent to an index for judging correctness of hypotheses of the respective particles for which hypothesis targets of an event occurrence source are generated. The particle weight [W_{pID}] is calculated as an event-target likelihood that is a similarity between the hypothesis targets of an event occurrence source set for the respective m particles (pID=1 to m) and an input event.

In FIG. 9, event information 401 inputted to the sound/image-integration processing unit 131 from the sound-event detecting unit 122 or the image-event detecting unit 112 and particles 411 to 413 held by the sound/image-integration processing unit 131 are shown. In the respective particles 411 to 413, the hypothesis targets set in the processing described above, i.e., the setting of hypotheses of an event occurrence source in step S102 of the flow shown in FIG. 7 are set. In an example shown in FIG. 9, as the hypothesis targets, targets are set as follows:

a target 2 (tID=2) 421 for the particle 1 (pID=1) 411;

a target n (tID=n) 422 for the particle 2 (pID=2) 412; and

a target n (tID=n) 423 for the particle m (pID=m) 413.

In the example shown in FIG. 9, the particle weights [W_{pID}] of the respective particles correspond to event-target likelihoods as follows:

the particle 1: an event-target likelihood between the event information 401 and the target 2 (tID=2) 421;

the particle 2: an event-target likelihood between the event information 401 and the target n (tID=n) 422; and

the particle m: an event-target likelihood between the event information 401 and the target n (tID=n) 423.

FIG. 10 shows an example of processing for calculating the particle weight [W_{pID}] for the particle 1 (pID−1).

Processing for calculating the particle weight [W_{pID}] shown in (2) in FIG. 10 is likelihood calculation processing same as that explained with reference to (2) in FIG. 8. In this example, the processing is executed as Calculation of an event-target likelihood as an index of a similarity between (1) the input event information and an only hypothesis target selected out of the particles.

(2) Likelihood calculation processing shown at the bottom of FIG. 10 is, like that explained with reference to (2) in FIG. 8, processing for individually calculating (a) an inter-Gaussian distribution likelihood [DL] as similarity data between an event concerning user position information and target data and (b) an inter-user confidence factor information (uID) likelihood [UL] as similarity data between an event concerning user identification information (face identification information or speaker identification information) and the target data.

Processing for calculating (a) the inter-Gaussian distribution likelihood [DL] as similarity data between an event concerning user position information and a hypothesis target is processing described below.

A Gaussian distribution corresponding to user position information in input event information is represented as N(mₑ, σₑ) and a Gaussian distribution corresponding to user position information of a hypothesis target selected out of the particles is represented as N(mₜ, σₜ). The inter-Gaussian distribution likelihood [DL] is calculated by the following equation:

DL=N(mt,σₜ+σₑ)x|me

The equation is an equation for calculating a value of a position of x=mₑ in a Gaussian distribution with distribution .σₜ+σₑ in the center mₜ.

Processing for calculating (b) the inter-user confidence factor information (uID) likelihood [UL] as similarity data between an event concerning user identification information (face identification information or speaker identification information) and a hypothesis target is processing described below.

Values (scores) of confidence factors of the respective users 1 to k of the user confidence factor information (uID) in the input event information are represented as Pe[i]. “i” is a variable corresponding to user identifiers 1 to k.

Values (scores) of confidence factors of the respective users 1 to k of user confidence factor information (uID) of a hypothesis target selected out of the particles are represented as Pt[i]. An inter-user confidence factor information (uID) likelihood

UL=ΣPₑ[i]×Pₜ[i]

The equation is an equation for calculating a sum of products of values (scores) of confidence factors of respective corresponding users included in the user confidence factor information (UID) of the two data. A value of the sum is the inter-user confidence factor information (uID) likelihood [UL].

The particle weight [W_{pID}] is calculated by using the two likelihoods, i.e., the inter-Gaussian distribution likelihood [DL] and the inter-user confidence factor information (uID) likelihood [UL]. In other words, the particle weight [W_{pID}] is calculated by the following equation by using a weight α (α=0 to 1):

[W_{pID}]=UL^{α}×DL^{1-α}.

where α. is 0 to 1.

The particle weight [W_{pID}] is calculated for the respective targets of the respective particles.

As in the processing for calculating the event-target likelihood [L_{pID, tiD}] described above, the weight [.α] applied to the calculation of the particle weight [W_{pID}] may be a value fixed in advance or may be set to be changed according to an input event. It is also possible that, for example, in the case in which the input event is an image, for example, when face detection is successful and position information can be acquired but face identification is failed, α is set to 0, the inter-user confidence factor information (uID) likelihood [UL] is set to 1, and the particle weight [W_{pID}] is calculated depending only on the inter-Gaussian likelihood [DL]. It is also possible that, for example, in the case in which the input event is sound, for example, when speaker identification is successful and speaker information can be acquired but acquisition of position information is failed, α is set to 0, the inter-Gaussian distribution likelihood [DL] is set to 1, and the particle weight [W_{pID}] is calculated depending only on the inter-user confidence factor information (uID) likelihood [UL].

The calculation of the particle weight [W_{pID}] corresponding to the respective particles in step S103 in the flow in FIG. 7 is executed as the processing explained with reference to FIGS. 9 and 10 in this way. Subsequently, in step S104, the sound/image-integration processing unit 131 executes processing for re-sampling particles on the basis of the particle weights [W_{pID}] of the respective particles set in step S103.

The particle re-sampling processing is executed as processing for selecting particles out of the m particles according to the particle weight [W_{pID}]. Specifically, when the number of particles m is 5, particle weights are set as follows:

the particle 1: the particle weight [W_{pID}]=0.40;

the particle 2: the particle weight [W_{pID}]=0.10;

the particle 3: the particle weight [W_{pID}]=0.25;

the particle 4: the particle weight [W_{pID}]=0.05; and

the particle 5: the particle weight [W_{pID}]=0.20.

In this case, the particle 1 is re-sampled at a probability of 40% and the particle 2 is re-sampled at a probability of 10%.

Actually, m is as large as 100 to 1000. A result of the re-sampling includes particles at a distribution ratio corresponding to weights of the particles.

According to this processing, a large number of particles with large particle weights [W_{pID}] remain.

Even after the re-sampling, the total number [m] of the particles is not changed.

After the re-sampling, the weights [W_{pID}] of the respective particles are reset.

The processing is repeated from step S101 according to an input of a new event.

In step S105, the sound/image-integration processing unit 131 executes processing for updating target data (user positions and user confidence actors) included in the respective particles. Respective targets include, as explained above with reference to FIG. 6 and the like, the following data:

(a) user positions: a probability distribution of presence positions corresponding to the respective targets [Gaussian distribution: N(mₜ, σₜ)]; and

(b) user confidence factors: values (scores) of probabilities that the respective targets are the respective users 1 to k as the user confidence factor information (uID) indicating who the respective targets are: Pt[i](i=1 to k), i.e.,

uIDₜ₁=Pt[1],

uIDₜ₂=Pt[2]

. . . , and

uIDₜₖ=Pt[k].

The update of the target data in step S105 is executed for each of (a) user positions and (b) user confidence factors. First, processing for updating (a) user positions will be described.

Renewal of a user position, he update of the user positions is executed as update processing at two stages, i.e.,

(a1) update processing applied to all the targets of all the particles and

(a2) update processing applied to event occurrence source hypothesis targets set for the respective particles.

(a1) The update processing applied to all the targets of all the particles is executed on all of targets selected as event occurrence source hypothesis targets and the other targets.

This processing is executed on the basis of an assumption that a variance of the user positions expands as time elapses. The user positions are updated by using a Kalman filter according to elapsed time from the last update processing and position information of an event.

An example of update processing in the case of one-dimensional position information is explained. First, the elapsed time from the last update processing is represented as [dt] and a predicted distribution of the user positions after dt for all the targets is calculated.

In other words, an expected value (average) [mₜ] and a variance [σₜ] of a Gaussian distribution N(mₜ, σₜ) as variance information of the user positions are updated as described below.

mₜ=mₜ+xc×dt

σₜ²=σₜ²+σc²×dt

where

mₜ is a predicted expected value (predicted state),

σₜ² is a predicted covariance (predicted estimate covariance),

xc is movement information (control model), and

σc² is noise (process noise).

When performed under a condition that users do not move, the update processing can be performed with xc set to 0. According to this calculation processing, the Gaussian distribution N(mₜ, σₜ) as the user position information included in all the targets is updated.

Concerning the targets as the hypotheses of an event occurrence source each set for the respective particles, update processing is executed by using a Gaussian distribution N(mₑ, σₑ) indicating user positions included in the event information inputted from the sound-event detecting unit 122 or the image-event detecting unit 112.

A Kalman gain is represented as K, an observed value (observed state) included in the input event information N(mₑ, σₑ) is represented as mₑ, and an observed value (observed covariance) included in the input event information N(mₑ, σₑ) is represented as σₑ². Update processing is performed as described below.

K=σₜ²/(σₜ²+σₑ²)

mₜ=mₜ+K(xc−mₜ)

σₜ²=(1−K)σₜ²

(b) The processing for updating user confidence factors executed as processing for updating target data is explained.

The target data includes, besides the user position in formation, values (scores) of probabilities that the respective targets are the respective users 1 to k as user confidence factor information (uID) indicating who the respective targets are [Pt[i](i=1 to k)]. In step S105, the sound/image-integration processing unit 131 also performs processing for updating the user confidence factor information (uID).

The update of the user confidence factor information (uID) of the targets included in the respective particles [Pt(i) (i=1 to k)] is performed by applying an update ratio [β] having a value in a range of 0 to 1 set in advance according to posterior probabilities for all registered users and the user confidence factor information (uID) included in the event information [Pe[i] (i=1 to k)] inputted from the sound-event detecting unit 122 or the image-event detecting unit 112.

The update of the user confidence factor information (uID) of the targets [Pt[i](i=1 to k)] is executed according to the following equation:

Pt[i]=(1−β)×Pt[i]+β*Pe[i],

where i is 1 to k and B is 0 to 1.

The update ratio [β] is a value in a range of 0 to 1 and is set in advance.

In step S105, the sound/image-integration processing unit 131 generates target information on the basis of the following data included in the updated target data and the respective particle weights [W_{pID}] and outputs the target information to the processing determining unit 132:

(a) user positions: a probability distribution of presence positions corresponding to the respective targets [Gaussian distribution: N(mₜ, σₜ)]; and

(b) user confidence factors: values (scores) of probabilities that the respective targets are the respective users 1 to k as the user confidence factor information (uID) indicating who the respective targets are: Pt[i](i=1 to k), i.e.,

uIDₜ₁=Pt[1]

uIDₜ₂=Pt[2],

. . . , and

uIDₜₖ=Pt[k].

On the basis of these kinds of data and the respective particle weights [W_{pID}], the target information is generated and output to the processing determining unit 132.

As explained with reference to FIG. 5, the target information is generated as weighted sum data of data corresponding to the respective targets (tID=1 to n) included in the respective particles (pID=1 to m). The target information is data shown in the target information 305 at the right end in FIG. 5.

The target information is generated as information including

(a) user position information and

(b) user confidence factor information of the respective targets (tID=1 to n).

For example, user position information in target information corresponding to the target (tID=1) is represented by the following formula:

$${\sum }_{i = 1}^{m} {W}_{i} \cdot N ( {m}_{i 1} , {σ}_{i 1} ) \qquad [ Equation 2 ]$$

In the formula, Wᵢ indicates the particle weight [W_{pID}].

User confidence factor information in target information corresponding to the target (tID=1) is represented by the following formula:

$$\begin{matrix}{\sum }_{i = 1}^{m} {W}_{i} \cdot {uID}_{i 11} \\ {\sum }_{i = 1}^{m} {W}_{i} \cdot {uID}_{i 12} \\ ⋮ \\ {\sum }_{i = 1}^{m} {W}_{i} \cdot {uID}_{i 1 k}\end{matrix} \qquad [ Equation 3 ]$$

In the formula, W_{I} indicates the particle weight [W_{pID}].

The sound/image-integration processing unit 131 calculates these kinds of target information for the respective n targets (tID=1 to n) and outputs the calculated target information to the processing determining unit 132.

Processing in step S106 shown in FIG. 7 will be descried.

In step S106, the sound/image-integration processing unit 131 calculates probabilities that the respective n targets (tID=1 to n) are event occurrence sources and outputs the probabilities to the processing determining unit 132 as signal information.

As explained above, the signal information indicating the event occurrence sources is, concerning a sound event, data indicating who spoke, i.e., a speaker and, concerning an image event, data indicating whose face a face included in an image is.

The sound/image-integration processing unit 131 calculates probabilities that the respective targets are event occurrence sources on the basis of the number of hypothesis targets of an event occurrence source set in the respective particles.

In other words, probabilities that the respective targets (tID=1 to n) are event occurrence sources are represented as P(tID=i), where, “i” is 1 to n. However, it is i=1−n.
In this case, probabilities that the respective targets are event occurrence sources are calculated as

P(tID=1): the number of targets to which tID=1 is allocated/m,

P(tID=2): the number of targets to which tID=2 is allocated/m,

. . . , and

P(tID=n): the number of targets to which tID=2 is allocated/m.

The sound/image-integration processing unit 131 outputs information generated by this calculation processing, i.e., the probabilities that the respective targets are event occurrence sources to the processing determining unit 132 as signal information.

When the processing in step S106 is finished, the sound/image-integration processing unit 131 returns to step S101 and shifts to a state of standby for an input of event information from the sound-event detecting unit 122 or the image-event detecting unit 112.

Steps S101 to S106 of the flow shown in FIG. 7 have been explained. Even when the sound/image-integration processing unit 131 may be unable to acquire the event information shown in FIG. 3B from the sound-event detecting unit 122 or the image-event detecting unit 112 in step S101, update of data of the targets included in the respective particles is executed in step S121. This update is processing that takes into account a change in user positions according to elapse of time.

This target update processing is processing same as (a1) the update processing applied to all the targets of all the particles in the explanation of step S105. This processing is executed on the basis of an assumption that a variance of the user positions expands as time elapses. The user positions are updated by using the Kalman filter according to elapsed time from the last update processing and position information of an event.

An example of update processing in the case of one-dimensional position information is explained. First, the elapsed time from the last update processing is represented as [dt] and a predicted distribution of the user positions after dt for all the targets is calculated. In other words, an expected value (average) [mₜ] and a variance [.σₜ] of a Gaussian distribution N(mₜ, σₜ) as variance information of the user positions are updated as described below.

mₜ=mₜ+xc×dt

σₜ²=σₜ²+σ_{c}²×dt

mₜ: Predicted expected value (predicted state)

σₜ²: predicted covariance (predicted estimate covariance)

xc: movement information (control model)

σ_{c}²: noise (process noise).

When the calculation processing is performed under a condition that users do not move, the update processing can be performed with xc set to 0. According to the calculation processing, the Gaussian distribution N(mₜ, σₜ) as the user position information included in all the targets is updated.

The user confidence factor information (uID) included in the targets of the respective particles is not updated unless posterior probabilities or scores [Pe] for all registered users of events can be acquired from event information.

When the processing in step S121 is finished, the sound/image-integration processing unit 131 returns to step S101 and shifts to the state of standby for an input of event information from the sound-event detecting unit 122 or the image-event detecting unit 112.

The processing executed by the sound/image-integration processing unit 131 has been explained with reference to FIG. 7. The sound/image-integration processing unit 131 repeatedly executes the processing according to the flow shown in FIG. 7 every time event information is inputted from the sound-event detecting unit 122 or the image-event detecting unit 112. By repeating the processing, weights of particles with targets having higher reliabilities set as hypothesis targets increase. By performing sampling processing based on the particle weights, particles having larger weights remain. As a result, data having high reliabilities similar to event information inputted from the sound-event detecting unit 122 or the image-event detecting unit 112 remain. Finally, information having high reliabilities, i.e.,

(a) target information as estimation information indicating whether plural users are present, respectively, and who the users are, and

(b) signal information indicating an event occurrence source such as a user who spoke is generated and outputted to the processing determining unit 132.

(2) An example of processing that improves the estimated performance of user identification by excluding independence between targets.

The above description of [(1) Processing for finding the position of a user and identifying the user by renewal of a hypothesis based on event information input] substantially corresponds to the description of Japanese Patent Application 2007-1930, which is a prior application filed by the same applicant as that of the present application.

The above processing includes processing for identifying users to determine who are users, processing for estimating the position of users, processing for identifying an event occurrence source, and so on by analyzing input information through a plurality of channels (also called modalities and modals), specifically image information obtained via a camera and sound information obtained via microphones.

However, in the above processing, the targets set to the respective particles are updated while retaining independence between the targets. In other wards, each of the targets is updated independent from each other while having no relevance to the updating of other target data. In such processing, the updating is performed without excluding an event which may actually not occur.

Specifically, target update may be performed in some cases on the bases of estimating that a different target is of the same user. Processing for excluding an event in which there are more than one same person is not performed during the estimation processing.

Hereinafter, an example of processing for performing an analysis with high precision while excluding inter-target independence will be described. In other words, uncertain, an estimated performance of user identification can be improved by stochastically unifying asynchronous position information and identification information including a plurality of channels (modalities, models) together and allowing a plurality of targets to handle the simultaneous occurrence probability (joint probability) of user IDs for all the users by excluding independence between the targets is handled when estimating where the targets are and who the targets are.

When the processing for finding the position of a user and identifying the user, which can be performed as one for generating target information {Position, User ID} as explained in the above-described [(1) Processing for finding the position of a user and identifying the user by renewal of a hypothesis based on event information input], is formulated, it can be described as a system that estimates probability [P] in the following mathematical formula (Formula 1).

P=(Xₜ,θₜ|zₜ,Xₜ₋₁) (formula 1)

where P(a|b) represents probability by which state a is generated when input b is obtained. Parameters included in the above formula are as follows:

t: time,

Xₜ: {xₜ¹, xₜ², . . . xₜ^{θ}, . . . xₜⁿ}: n-persons' target information, where x={xₚ,xᵤ}: target information {Position, User ID},

zₜ: {Zpₜ, Zuₜ}: observed value {Position, User ID} at time t, and

θₜ: state (θ=1 to n) where observed value z₁ at time t is a source of generating target information xθof target [θ].

Furthermore, Zₜ={zpₜ, zuₜ) is an observed value {Position, User ID} at time t and corresponds to event invention in the above-descried [(1) Processing for finding the position of a user and identifying the user by renewal of a hypothesis based on event information input]

In other words, zpₜ is user position information (position) included in the event information, for example the user position information represented by a Gaussian distribution as shown in (a) of (1) in FIG. 8.

zuₜ is user identification information (User ID) included in the event information for example it corresponds to user identification information represented as a confidence factor value of each of the users 1 to k shown in (b) of (1) in FIG. 8.

Probability P represented by the above formula 1, P=(Xₜ, θₜ|zₜ, Xₜ₋₁), represents the probability value of occurrence of two states represented on the left side of the formula, the state of which the observed value [zₜ] at time t is a source of generating target information [xθ] (θ=1 to n) (state 1) and the state of which target information [Xₜ] is generated at time t, when two inputs represented on the right side of the above formula, the observed value [zₜ] at time t (input 1) and the target information [Xₜ₋₁] at the last observed time t−1 (input 2), are obtained.

The processing for finding the position of a user and identifying the user, which can be performed as one for generating target information {Position, User ID} as explained in the above-described [(1) Processing for finding the position of a user and identifying the user by renewal of a hypothesis based on event information input] can be described as a system that estimates probability [P] in the above formula (formula 1).

If the above-mentioned probability formula (formula 1) is now factorized by θ, it can be converted as follows:

P(Xₜ,θₜ|zₜ,Xₜ₋₁)=P(Xₜ|θₜ,zₜ,Xₜ₋₁)×P(θₜ|zₜ,Xₜ₋₁)

Here, the first-half formula and the second-half formula in the result of the factorization are represented by (formula 2) and (formula 3), respectively. In other words, P(Xₜ|θₜ, zₜ, Xₜ₋₁) is represented as (formula 2) and P(θₜ|zₜ, Xₜ₋₁) is represented as (formula 3). Therefore, (formula 1)=(formula 2)×(formula 3).

The above formula (formula 3), P(θₜ|zₜ, Xₜ₋₁), is provided with the following inputs:

an observed value [zₜ] at time t (input 1) and

target information [Xₜ−1] at the last observed time t−1 (input 2).

When these inputs are obtained, the state [θₜ] is that a generation source of the observed value [zₜ] is [xθ] (state 1). The formula is one for calculating probability that the above-mentioned state will occur.

In the above-described [(1) Processing for finding the position of a user and identifying the user by renewal of a hypothesis based on event information input], the probability is estimated by processing with particle filters. Specifically, for example, the estimation is performed by the processing using [Using Rao-Blackwellised Particle Filters].

On the other hand, he above formula (formula 2), P(Xₜ|θₜ, zₜ, Xₜ₋₁), is provided with the following inputs:

an observed value [zₜ] at time t (input 1),

target information [Xₜ₋₁] at the last observed time t−1 (input 2), and

probability [θₜ] that a generation source of the observed value [zₜ] is [xθ].

When these inputs are obtained, the target state [Xₜ] is obtained at time t (state). The formula is one for representing probability that the above-mentioned state will occur.

To estimate the probability of occurrence of the state represented by the above formula (formula 2), P(Xₜ|θₜ, zₜ, Xₜ₋₁), target information [Xₜ] represented as an estimating state value is expanded to target information [Xpₜ] corresponding to the position information and target information [Xuₜ] corresponding to user identification information.

This expansion processing allows the above formula (formula 2) to be represented as follows:

P(Xₜ|θₜ,zₜ,Xₜ₋₁)=P(Xpₜ,Xuₜ|θₜ,zpₜ,zuₜ,Xpₜ₋₁,Xuₜ₋₁)

where
zpₜ: target information included in an observed value [zₜ] at time t, and
zuₜ: user identification information included in the observed value [zₜ] at time t.

If the target information [Xpₜ] corresponding to the position information and the target information [Xuₜ] corresponding to user identification information are independent from each other, then the expansion formula of the above formula 2 can be represented as a multiplication of two formulas as follows:

$$\begin{matrix}P ( {X}_{t} \vert {θ}_{t} , {z}_{t} , {X}_{t - 1} ) = P ( {Xp}_{t} , {Xu}_{t} \vert {θ}_{t} , {zp}_{t} , {zu}_{t} , {Xp}_{t - 1} , {Xu}_{t - 1} ) \\ = P ( {Xp}_{t} \vert {θ}_{t} , {zp}_{t} , {Xp}_{t - 1} ) \times P ( {Xu}_{t} \vert {θ}_{t} , {zu}_{t} , {Xu}_{t - 1} )\end{matrix}$$

Here, the first-half formula and the second-half formula in the above multiplication formula are represented by (formula 4) and (formula 5), respectively. In other words, P(Xpₜ|θₜ, zpₜ, Xpₜ₋₁) is represented as (formula 4) and P(Xuₜ|θₜ, zuₜ, Xuₜ₋₁) is represented as (formula 5). Then, the multiplication formula can be represented as (formula 2)=(formula 4)×(formula 5).

Target information, which is updated by the observed value [zpₜ] corresponding to the position in the above formula (formula 4), P(Xpₜ|θₜ, zpₜ, Xpₜ₋₁), is only target information [xpₜθ] with respect to the position of a specific target (θ).

Here, the target information [xpₜθ]: xpₜ¹, xpₜ², . . . , xpₜⁿ with respect to the positions corresponding to the respective targets θ=1 to n is different from one another, then the above formula (formula 4), P(Xpₜ|θₜ, zpₜ, Xpₜ₋₁), can be expanded as follows:

$$\begin{matrix}P ( {Xp}_{t} \vert {θ}_{t} , {zp}_{t} , {Xp}_{t - 1} ) = P ( \begin{matrix}{xp}_{t}^{1} , {xp}_{t}^{2} , … , {xp}_{t}^{n} \vert {θ}_{t} , {zp}_{t} , {xp}_{t - 1}^{t} , \\ {xp}_{t - 1}^{2} , … , {xp}_{t - 1}^{n}\end{matrix} ) \\ = P ( {xp}_{t}^{1} \vert {xp}_{t - 1}^{1} ) P ( {xp}_{t}^{2} \vert {xp}_{t - 1}^{2} ) , … , \\ P ( {xp}_{t} θ \vert {zp}_{t} , {xp}_{t - 1} θ ) , … , P ( {xp}_{t}^{n} \vert {xp}_{t - 1}^{n} )\end{matrix}$$

Therefore, the formula (formula 4) can be expanded as a multiplication formula of each of probability values of the corresponding targets (θ=1 to n), so that the target information [xpₜθ] about the position of the specific target (θ) can be only influenced by the update with the observed value [zpₜ].

Furthermore, in the processing explained in the above-described [(1) Processing for finding the position of a user and identifying the user by renewal of a hypothesis based on event information input], the value corresponding to the formula 4 is estimated using a Kalman filter.

However, in the processing in the above-described [(1) Processing for finding the position of a user and identifying the user by renewal of a hypothesis based on event information input], the update of user positions including target data set to the respective particles is executed as update processing at two stages, i.e.,

(a1) update processing to be applied to all the targets of all the particles and

(a2) update processing to be applied to event occurrence source hypothesis targets set for the respective particles.

The processing (a1), i.e., the update processing to be applied to all the targets of all the particles, is executed on all of targets selected as event occurrence source hypothesis targets and the other targets. This processing is executed on the basis of an assumption that a variance of the user positions expands as time elapses. The user positions are updated by using a Kalman filter according to elapsed time from the last update processing and position information of an event.

In other words, it can be represented by the formula P(xpₜ|xpₜ₋₁).

This probability-calculation processing is employed in the estimation processing using a Kalman filter only for a movement model (time attenuation)

In addition, the update processing (a2) applied to event occurrence source hypothesis targets set for the respective particles is executed by using a Gaussian distribution N(mₑ, σₑ) indicating user positions included in the event information inputted from the sound-event detecting unit 122 or the image-event detecting unit 112.

In other words, it can be represented by the formula P(xpₜ|zpₜ, xpₜ₋₁).

This probability-calculation processing is employed in the estimation processing using a Kalman filter for a movement model and an observation model.

Next, the formula (formula 5) corresponding to the user identification information (User ID) obtained by expanding the above formula 2 is analyzed. The formula is as follows:

P(Xuₜ|θₜ,zuₜ,Xuₜ₋₁) (formula 5)

In this formula (formula 5), the target information, which is updated by the observed value [zuₜ] corresponding to the user identification information (User ID), is only target information [xuₜθ] with respect to the user identification information of a specific target (θ).

Here, if the target information [xuₜθ]: xuₜ¹, xuₜ², . . . , xuₜⁿ about the user identification information corresponding to the respective targets θ=1 to n is independent from one another, the above formula (formula 5), P(Xuₜ|θₜ, zuₜ, Xuₜ₋₁), can be expanded as follows:

$$\begin{matrix}P ( {Xu}_{t} \vert {θ}_{t} , {zu}_{t} , {Xu}_{t - 1} ) = P ( \begin{matrix}{xu}_{t}^{1} , {xu}_{t}^{2} , … , {xu}_{t}^{n} \vert {θ}_{t} , {zu}_{t} , {xu}_{t - 1}^{1} , \\ {xu}_{t - 1}^{2} , … , {xu}_{t - 1}^{n}\end{matrix} ) \\ = P ( {xu}_{t}^{1} \vert {xu}_{t - 1}^{1} ) P ( {xu}_{t}^{2} \vert {xu}_{t - 1}^{2} ) … \\ P ( {xu}_{t} θ \vert {zu}_{t} , {xu}_{t - 1} θ ) … P ( {xu}_{t}^{n} \vert {xu}_{t - 1}^{n} )\end{matrix}$$

Therefore, the formula (formula 5) can be expanded as a multiplication formula of each of probability values of the corresponding targets (θ=1 to n), so that the target information [xuₜθ] about the position of the specific target (θ) can be only influenced by the update with the observed value [zuₜ].

Furthermore, the target-update processing based on the user identification information, which is performed by the processing explained in the above-descried [(1) Processing for finding the position of a user and identifying the user by renewal of a hypothesis based on event information input] is performed as follows.

The targets set to the respective particles include probability values (scores), Pt[i](i=1 to k), of which the respective targets are the respective users 1 to k as the user confidence factor information (uID) indicating who the respective targets are.

The target update with the user identification information included in the event information is set so that the probability value does not change as long as there is no observed value. In other words, the probability is represented by a formula, P(xuₜ|xuₜ₋₁) which is set so as not to be changed as long as there is no observed value.

The update of the user confidence factor information (uID), Pt[i](i=1 to k), of the targets included in the respective particles is performed by application of an update ratio [β] having a value in a range of 0 to 1 set in advance. Here, the update ratio [β] is determined in advance based on the posterior probability of each of all the registered users and the user confidence factor information (uID): Pe [i] (i=1 to k) included in the event information inputted from the sound-event detecting unit 122 or the image-event detecting unit 112.

The update of the user confidence factor information (uID): Pt[i](i=1 to k) of the targets is performed by the following formula:

Pt[i]=(1−β)×Pt[i]+β*Pe[i]

where i=1 to k and β=0 to 1. Here, the update ratio [β] is a value in a range of 0 to 1 and is set in advance.

This processing can be represented by the following probability-calculation formula:

P(xuₜ|zuₜ,xuₜ₋₁)

The target-update processing based on the user identification information explained in the above-described [(1) Processing for finding the position of a user and identifying the user by renewal of a hypothesis based on event information input] is comparable to the execution of the estimation processing of probability P in the following formula (formula 5) corresponding to the user identification information (User ID) obtained by expanding the above formula (formula 2):

P(Xuₜ|θₜ,zuₜ,Xuₜ₋₁) (formula 5)

Thus, it is comparable to execute the estimation processing of the probability P of the formula (formula 5). However, in the above-described [(1) Processing for finding the position of a user and identifying the user by renewal of a hypothesis based on event information input], the processing is performed while retaining the independence of user identification information (User ID) between the targets.

Therefore, in some cases, even in the case of a plurality of different targets, it is determined that the same user identifier (uID: User ID) is the most probable user identifier and the update is then performed on such a determination. In other words, in some cases, the update is performed by estimation processing in an actually uncommon state in which, for example, any of plural targets corresponds to the same user even if such a state does not actually occur.

In addition, the processing is performed with assumed independence of user identifiers (uID: User ID) between targets. Thus, the target information to be updated by an observed value [zuₜ] corresponding to the user identification information is only the target information [xuₜθ] of a specific target (θ). Therefore, there is a request of observed values [zuₜ] for all the targets to update the user identification information (uID: User ID) of all the targets.

In this way, in the above-described [(1) Processing for finding the position of a user and identifying the user by renewal of a hypothesis based on event information input], the analytical processing is executed while the independence between the targets is retained. Therefore, the estimation processing is executed without excluding an event which may actually not occur. Thus, the targets are unnecessarily updated. Besides, decreases in efficiency and accuracy of estimation processing of user identification may occur.

Hereinafter, an embodiment of the present invention that overcomes the above disadvantages will be described. In this embodiment, processing of updating plural target data is executed based on one observation data while excluding the independence between the targets to correlate them to each other. The execution of such processing allows the update to be performed while excluding an event which may actually not occur, thereby realizing an efficient analysis with high accuracy.

In an information processing apparatus according to an embodiment of the present invention, a sound sound/image-integration processing unit 131 executes processing for updating target data that includes user-confidence factor information indicating which of users correspond to a target provided as an event occurrence source on the basis of user identification information included in the event information. To execute such processing, the simultaneous occurrence probability (joint probability) of candidate data that allows the targets to corresponding to the respective users is updated on the basis of user identification information included in the event invention. Then, processing for calculating a user confidence factor corresponding to the target by application of the value of the updated simultaneous occurrence probability is executed.

As the simultaneous occurrence probability (joint probability) of the user identification information (User ID) is processed for all the targets by excluding independence between the targets, an estimated performance of user identification can be improved. Hereinafter, processing which can be executed by the sound/image-integration processing unit 131 will be described.

(A) Exclusion of Independence Between Targets from User-Estimation Processing

The sound/image-integration processing unit 131 executes processing from which independence of target information [Xuₜ] corresponding to user identification information is excluded by application of the above-described formula (formula 5). That is, the following formula is applied:

P(Xuₜ|θₜ,zuₜ,Xuₜ₋₁) (formula 5)

The series of processing to derive the above formula (formula 5) will be simply summarized again. As described above, when probabilities (=signal information) that the respective targets are event occurrence sources (=signal information) are represented as P, the processing for calculating the probability P can be formulized and represented as follows:

P(Xₜ,θₜ|zₜ,Xₜ₋₁) (formula 1)

Furthermore, when the formula (formula 1) is factorized by θ, the formula can be converted as follows:

P(Xₜ,θₜ|zₜ,Xₜ₋₁)=P(Xₜ|θₜ,zₜ,Xₜ₋₁)×P(θₜ|zₜ,Xₜ₋₁)

Here, the first-half formula and the second-half formula in the result of the factorization are represented by (formula 2) and (formula 3), respectively. In other words, P(Xₜ|θₜ, zₜ, Xₜ₋₁) is represented as (formula 2) and P(θₜ|zₜ, Xₜ₋₁) is represented as (formula 3). Therefore, (formula 1)=(formula 2)×(formula 3).

The formula (formula 3), P(θₜ|zₜ, Xₜ₋₁), is provided with the following inputs:

an observed value [zₜ] at time t (input 1) and

target information [Xₜ₋₁] at the last observed time [t−1] (input 2).

When these inputs are obtained, the state [θₜ] is that a generation source of the observed value [zₜ] is [xθ] (state 1). The formula is one for calculating probability that the above-mentioned state will occur.

On the other hand, the above formula (formula 2), P(Xₜ|θₜ, zₜ, Xₜ₋₁), is provided with the following inputs:

an observed value [Zₜ] at time t (input 1),

target information [Xₜ₋₁] at the last observed time [t−1] (input 2), and

probability [θₜ] that a generation source of the observed value [zₜ] is [xθ].

When these inputs are obtained, the target state [Xₜ] is obtained at time t (state). The formula is one for representing probability that the above-mentioned state will occur.

If target information [Xuₜ] corresponding to target information [Xpₜ] corresponding to position information and user identification information is assumed to be independent, the above-mentioned (formula 2) can be described as a multiplication formula as follows:

$$\begin{matrix}P ( {X}_{t} \vert {θ}_{t} , {z}_{t} , {X}_{t - 1} ) = P ( {Xp}_{t} , {Xu}_{t} \vert {θ}_{t} , {zp}_{t} , {zu}_{t} , {Xp}_{t - 1} , {Xu}_{t - 1} ) \\ = P ( {Xp}_{t} \vert {θ}_{t} , {zp}_{t} , {Xp}_{t - 1} ) \times P ( {Xu}_{t} \vert {θ}_{t} , {zu}_{t} , {Xu}_{t - 1} )\end{matrix}$$

Here, the first-half formula and the second-half formula in the above multiplication formula are represented by (formula 4) and (formula 5), respectively. In other words, P(Xpₜ|θₜ, zpₜ, Xpₜ₋₁) is represented as (formula 4) and P(Xuₜ|θₜ, zuₜ, Xuₜ₋₁) is represented as (formula 5). Then, the multiplication formula can be represented as (formula 2)=(formula 4)×(formula 5).

In this way, the formula (formula 5) corresponds to the user identification information (User ID) obtained by expanding the above formula 2 is analyzed. The formula is as follows:

P(Xuₜ|θₜ,zuₜ,Xuₜ₋₁) (formula 5)

In this formula (formula 5), the target information, which is updated by the observed value [zuₜ] corresponding to the user identification information (User ID), is only target information [xuₜθ] with respect to the user identification information of a specific target (θ).

This formula (formula 5), P(Xuₜ|θₜ, zuₜ, Xuₜ₋₁), can be expanded as follows:

P(Xuₜ|θₜ,zuₜ,Xuₜ₋₁)=P(xuₜ¹,xuₜ², . . . , xuₜⁿ|θₜ,zuₜ,xuₜ₋₁¹,xuₜ₋₁², . . . , xuₜ₋₁ⁿ)

Here, target-update processing in which the independence between the targets of the target information [Xuₜ] corresponding to user identification information is not hypothesized. In other words, processing that considers the simultaneous occurrence probability (joint probability) which is probability that any of plural events will occur. Bayes' theorem is used for this processing. According to Bayes' theorem, when P(x): probability that event x will occur (prior probability) and P(x|z): probability that event x will occur after the generation of event z (posterior probability) are defined, the following formula is formulated:

P(x|z)=(P(z|x)P(x))/P(z)

Bayes' theorem, P(x|z)=(P(z|x) P(x))/P(z), is used for expanding the above-described formula (formula 5), P(Xuₜ|θₜ, zuₜ, Xuₜ₋₁), which corresponds to the above-described user identification information (User ID).

The result of the expansion is as follows:

P(Xuₜ|θₜ,zuₜ,Xuₜ₋₁)=P(θₜ,zuₜ,Xuₜ₋₁|Xuₜ)P(Xuₜ)/P(θₜ,zuₜ,Xuₜ₋₁) (formula 6)

In the above formula (formula 6), parameters mean as follows:

θₜ: state (θ=1 to n) where observed value z₁ at time t is a source of generating target information xθ of target [θ]; and

zuₜ: user identification information at time t included in the observed value [zₜ] at time t.

When these parameters, θₜ and zuₜ, only depends on the target information [Xuₜ] at time t which corresponds to the user identification information (but not depends on the target information [Xuₜ₋₁]), the above formula (formula 6) can be further expanded as follows:

P(Xuₜ|θₜ,zuₜ,Xuₜ₋₁)=P(θₜ,zuₜ,Xuₜ₋₁|Xuₜ)P(Xuₜ)/P(θₜ,zuₜ,Xuₜ₋₁)=P(θₜ,zuₜ|Xuₜ)P(Xuₜ₋₁|Xuₜ)P(Xuₜ)/P(θₜ,zuₜ)P(Xuₜ₋₁) (formula 7)

The estimation of user identification, or user-identification processing, is executed by calculating the above formula (formula 7). Furthermore, if there is a demand of obtaining a user confidence factor (uID) for one target i, or the probability of xu (User ID), it is obtained by marginalizing probability that the target is the user identifier (User ID) in the simultaneous occurrence probability (joint probability). For example, it is calculated using the following formula:

P(xuⁱ)=Σ_{Xu=xui}P(Xu)

A specific example of the processing using such a formula will be described later.

Hereinafter, as examples of the processing on which the above formula (formula 7) are applied, the following examples will be described:

(a) an example of analytical processing in which independence between targets is retained;

(b) an example of analytical processing according to an embodiment of the present invention in which independence between targets is excluded; and

(c) an example of analytical processing that gives consideration to the presence of an unregistered user in an example of analytical processing according to an embodiment of the present invention in which independence between targets is excluded.

Now, these processing examples will be described. Here, the processing example (a) will be described for the comparison with the processing example (b) according to the embodiment of the present invention.

(a) An Example of Analytical Processing in which Independence Between Targets is Retained

First, an example of analytical processing in which independence between targets is retained will be described. As described above, Bayes' theorem is employed to expand the formula (formula 5), which corresponds to the user identification information (User ID):

P(Xuₜ|θₜ,zuₜ,Xuₜ₋₁) (formula 5)

Thus, the following formula (formula 7) is obtained:

$$\begin{matrix}P ( {Xu}_{t} \vert {θ}_{t} , {zu}_{t} , {Xu}_{t - 1} ) = \frac{P ( {θ}_{t} , {zu}_{t} , {Xu}_{t - 1} \vert {Xu}_{t} ) P ( {Xu}_{t} )}{P ( {θ}_{t} , {zu}_{t} , {Xu}_{t - 1} )} \\ = \frac{\begin{matrix}P ( {θ}_{t} , {zu}_{t} \vert {Xu}_{t} ) \\ P ( {Xu}_{t - 1} \vert {Xu}_{t} ) P ( {Xu}_{t} )\end{matrix}}{P ( {θ}_{t} , {zu}_{t} ) P ( {Xu}_{t - 1} )} …\end{matrix} \qquad ( formula 7 )$$

Here, it is assumed that P(Xuₜ), P(θₜ, zuₜ), and P(Xuₜ₋₁) in formula (7) are uniform prior probability, then the formulae, (formula 5) and (formula 7), can be represented as follows:

P(Xuₜ|θₜ,zuₜ,Xuₜ₋₁) (formula 5)

=P(θₜ,zuₜ|Xuₜ)P(Xuₜ₋₁|Xuₜ)P(Xuₜ)/P(θₜ,zuₜ)P(Xuₜ₋₁) (formula 7)

˜P(θₜ,zuₜ|Xuₜ)×P(Xuₜ₋₁|Xuₜ) (formula 8)×(formula 9),

where “˜” means “proportional to”.

Therefore, the formulae, (formula 5) and (formula 7), can be represented as the following formula (formula 10):

P(Xuₜ|θₜ,zuₜ,Xuₜ₋₁) (formula 5)

=R×P(θₜ,zuₜ|Xuₜ)P(Xuₜ₋₁|Xuₜ) (formula 10)

where R represents a regularization term.
Thus, formula 10 and formula 5 are represented as follows:

formula 10=R×(formula 8)×(formula 9); and

formula 5=R×(formula 8)×(formula 9).

Here, the formula (formula 8) is represented as follows:

(θₜ,zuₜ|Xuₜ) (formula 8)

When the target information [Xuₜ] corresponding to user identification information is obtained at time t, the formula (8) is probability that the observed value [zuₜ] is observation information from a specific target (θ) with respect to the user identification information included in the target information. Such probability is defined as [prior probability P] of the observed value.

In addition, the formula (formula 9) is represented as follows:

P(Xuₜ₋₁|Xuₜ) (formula 9)

When the target information [Xuₜ] corresponding to user identification information is obtained at time [t], the formula (9) is probability that target information [Xuₜ₋₁] corresponding to the user identification information is obtained at the last observation time [t−1]. Such probability is defined as [state transition probability P].

In other words, the following equation is obtained:

(formula 5)=R×([prior probability P])×([state transition probability P])

For example, when the target information [Xuₜ] in the calculation formulation (formulation 8) for [prior probability P] of the observed value is individually defined as target information [xuₜ¹, xuₜ², . . . , xuₜθ, . . . , xuₜⁿ], the formula (formula 8) can be represented as follows:

P(θₜ,zuₜ|Xuₜ)=P(θₜ,zuₜ|xuₜ¹,xuₜ², . . . , xuₜθ, . . . , xuₜⁿ)

In the above formula, when the prior probability P of the observed value is set to P=A in the case of xuₜθ=zuₜ or P=B in other cases.

Furthermore, the probability A and the probability B are set to A>B.

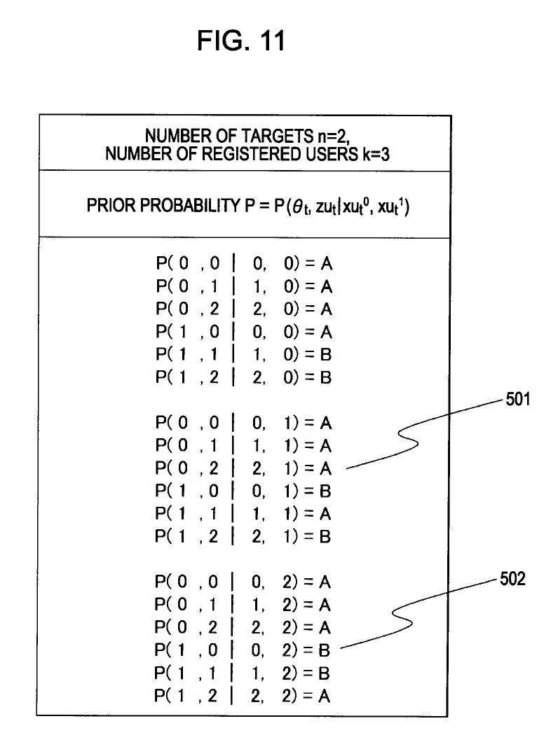

FIG. 11 illustrates an example of processing for calculating prior probability P when the number of targets is two (n=2) (target ID (tID=0 to 1)), and the number of registered users is three (k=3) (user ID (uID=0 to 2))

For example, entry 501, P(θₜ, zuₜ|xuₜ⁰, xuₜ¹)=P(0, 2|2, 1), located almost in the middle of FIG. 11 indicates the following probability:

if xuₜ⁰=2: target ID (tID)=0 corresponds to user ID (uID=2) and
xuₜ¹=1: target ID (tID)=1 corresponds to user ID (uID=1), then
observation information zuₜ of user ID=2 is obtained from θₜ=0, zuₜ=2: target ID=0.

In this case, parameters represent xuₜθ=xuₜ⁰=2 and zuₜ=2, and xuₜθ=zuₜ is then realized.

Therefore, prior probability P is represented as follows:

P(θₜ,zuₜ|xuₜ⁰,xuₜ¹)=P(0,2|2,1)=A

In addition, entry 502, P(θₜ, zuₜ|xuₜ⁰, xuₜ¹)=P(1, 0|0, 2), represents the following probability:

if xuₜ⁰=0: target ID (tID)=0 corresponds to user ID (uID=0) and
xuₜ¹=2: target ID (tID)=1 corresponds to user ID (uID=2), then observation information zuₜ of user ID=0 is obtained from θₜ=1, zuₜ=0: target ID=1.

In this case, parameters represent xuₜθ=xuₜ¹θ=2 and zuₜ=0, and xuₜθ=zuₜ is then unrealized.

Therefore, prior probability P is represented as follows:

P(θₜ,zuₜ|xuₜ⁰,xuₜ¹)=P(1,0|0,2)=B

Furthermore, the state transition probability P is represented by the following formula (formula 9):

P(Xuₜ₋₁|Xuₜ) (formula 9)

When the user identifier (User ID) is not changed in all the users, the state transition probability P is set to P=C. In other cases, it is set to P=D.

Here, the probability C and the probability D are set to C>D.

State Transition Probability Under Such a Setting

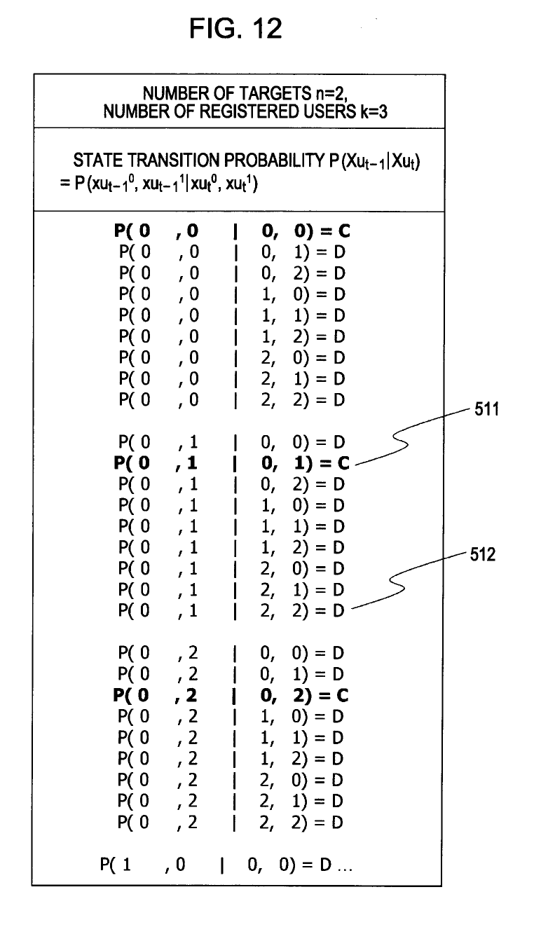

FIG. 12 illustrates an example of calculating state transition probability when the number of targets is two (n=2 (0 to 1)) and the number of registered users is three (k=3 (0 to 2)).

Entry 511 shown in FIG. 12, P(xₜ₋₁⁰, xuₜ₋₁¹|xuₜ⁰, xuₜ¹)=P(0,1|0,1), shows the following probability:

if xuₜ⁰=0: target ID (tID)=0 corresponds to user ID (uID=0) at time t and
xuₜ¹=0: target ID (tID)=1 corresponds to user ID (uID=1) at time t, then
xuₜ₋₁⁰=0: target ID (tID)=0 becomes user ID (uID=0) at time t−1 and
xuₜ₋₁¹=1: target ID (tID)=1 becomes user ID (uID=1) at time t−1.

In this case, there is no change between user identifier (User ID) at time t and one at time t−1 with respect to all the targets. Thus, the state transition probability P becomes P=C.

In addition, entry 512 shown in FIG. 12, P(xₜ₋₁⁰, xuₜ₋₁¹|xuₜ⁰, xuₜ¹)=P(0,1|2,2), shows the following probability:

if xuₜ⁰=0: target ID (tID)=0 corresponds to user ID (uID=2) at time t and
xuₜ¹=1: target ID (tID)=1 corresponds to user ID (uID=0) at time t, then
xuₜ₋₁⁰=0: target ID (tID)=0 becomes user ID (uID=0) at time t−1 and
xuₜ₋₁¹=1: target ID (tID)=1 becomes user ID (uID=1) at time t−1.

In this entry 512, the state transition probability is not one having no change between user identifier (User ID) at time t and one at time t−1 with respect to all the targets. It causes a change in user identifier with respect to at lest one target. Therefore, the state transition probability is se to P=D.

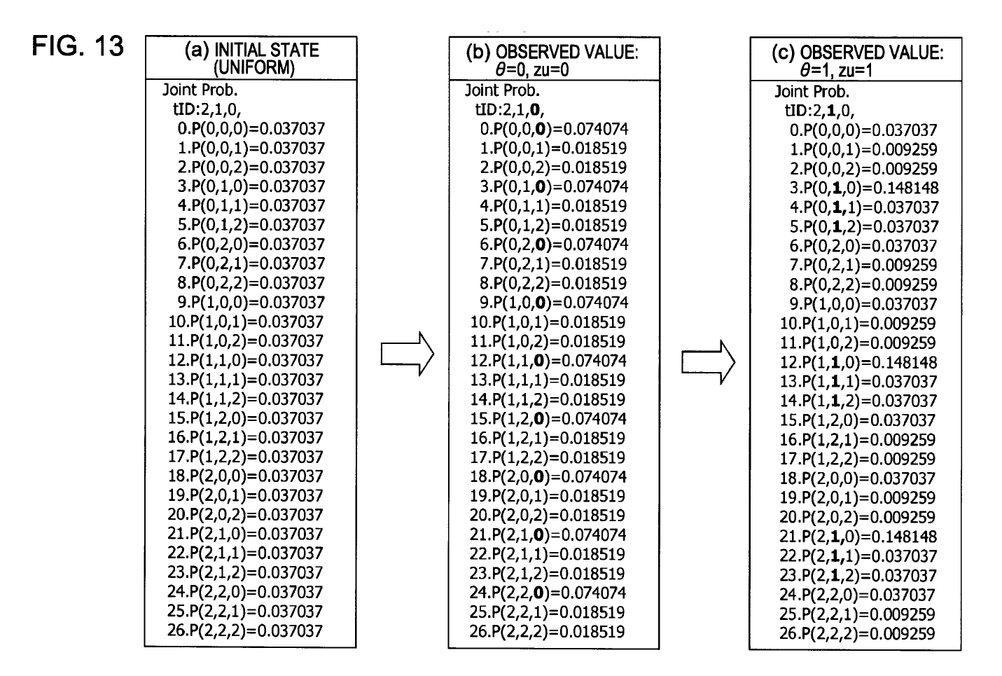

In FIG. 13, the formula (formula 10) is represented as follows:

P(Xuₜ|θₜ,zuₜ,Xuₜ₋₁) (formula 5)

=R×P(θₜ,zuₜ|Xuₜ)P(Xuₜ₋₁|Xuₜ) (formula 10)=(R×(formula 8)×(formula 9))

In this formula, the probability values, i.e., user confidence factors of user IDs (0 to 2) for the respective target IDs (2, 1, 0), which are initial values before obtaining observed values as event information, are set to uniform ((a) of FIG. 13).

Then, the probability is set to as follows:

the probability A=0.8 and B=0.2 corresponding to prior probability P represented by the above formula (formula 8) and
the probability C=1.0 and D=0.0 corresponding to prior probability P represented by the above formula (formula 9).

In other words, probability is set to as follows:

[prior probability P] represented by the formula (formula 8) is represented as follows:

P(θₜ,zuₜ|Xuₜ)=P(θₜ,zuₜ|xuₜ¹,xuₜ², . . . , xuₜ^{θ}, . . . , xuₜⁿ)

In this formula, the prior probability P of the observed value is set to xuₜθ=zuₜ. In this case, prior probability P is set to P=A=0.8. In other cases, prior probability is set to P=B=0.2.

Furthermore, the probability is set to as follows:

[state transition probability P] expressed by the formula (formula 8) is represented as follows:

P(Xuₜ₋₁|Xuₜ)

In this formula, the state transition probability P is set to P=C=1.0 when there is no change between the user identifier (User ID) at time t and the user identifier (User ID) at time t−1 with respect to all the targets. In other cases, in contrast, the state transition probability P is set to P=C=0.0.

A series of observation information is observed in order under the above probability setting at two observation times,

“θ=0, zu=0” and

“θ=1, zu=1”.

FIG. 13 illustrates an example of variations of probabilities of User IDs (0 to 2) for target IDs (2, 1, 0), or user confidence factors (uIDs).

The probability is calculated as simultaneous occurrence probability (joint probability) with respect to data corresponding to all the user IDs (0 to 2) for all the target IDs (2, 1, 0).

Furthermore, “θ=0, zu=0” indicates that the observation information [zu] corresponding to the user identifier (UID=0) from the target (θ=0).

“θ=1, zu=1” indicates that the observation information [zu] corresponding to the user identifier (UID=1) from the target (θ=1).

Candidates of user IDs (uID=0 to 2) corresponding to three target IDs (tID=0, 1, 2) are tID0, 1, and 2=(0, 0, 0) to (2, 2, 2) as shown in the column of (a) Initial state shown in FIG. 13. There are 27 different candidate data.

Simultaneous occurrence probability (joint probability) is calculated for each of these 27 different candidate data as an user confidence factor corresponding to all the user IDs (0 to 2) for all the target IDS (2, 1, 0).

At the initial state, the simultaneous occurrence probability of 27 different candidate data is set to uniform. There are 27 candidates in total, so that the probability P of one candidate data is set to P=1.0/27=0.037037.

In FIG. 13, (b) represents, when observation information [θ=0, zu=0] is observed, variations of user confidence factors (confidence factors of all the user IDs (0 to 2) corresponding to all the target IDs (2, 1, 0)) calculated as simultaneous occurrence probability (joint probability).

The observation information [θ=0, zu=0] is one in which the observation information from target ID=0 corresponds to user ID=0.

Based on the observation information, from 27 candidates, the probability P (simultaneous occurrence probability (joint probability)) of candidate data in which user ID=0 is set to target ID=0 is increased, while the probability P of others is lowered.

The calculation of probability is executed according to the following formulation.

P(Xuₜ|θₜ,zuₜ,Xuₜ₋₁) (formula 5)

=R*P(θₜ,zuₜ|Xuₜ)P(Xuₜ₋₁|Xuₜ) ((formula 10)=(formula 8)×(formula 9))

In this formulation, the calculation of probability is performed on the basis of the setting of:
probability A=0.8, B=0.2 for prior probability P represented by the above formula (formula 8); and
probability C=1.0, D=0.0 for prior probability P represented by the above formula (formula 8).

As shown in FIG. 13 (b), the calculation results in the following probability:

probability P=0.074074 for candidates with user ID=0 set to tID=0; and

probability P=0.018519 for other candidates.

In FIG. 13, furthermore, (c) represents, when observation information [θ=0, zu=0] is observed, variations of user confidence factors (confidence factors of all the user IDs (0 to 2) corresponding to all the target IDS (2, 1, 0)) calculated as simultaneous occurrence probability (joint probability).

The observation information [θ=1, zu=1] is one in which the observation information from target ID=1 corresponds to user ID=1.

Based on the observation information, from 27 candidates, the probability P (simultaneous occurrence probability (joint probability)) of candidate data in which user ID=1 is set to target ID=1 is increased, while the probability P of others is lowered.

As shown in FIG. 13 (c), the results can be classified into three different probability values (simultaneous occurrence probability (joint probability)). Candidates with the highest probability satisfies the conditions of user ID=0 set to tID=0 and user ID=1 set to tID=1, resulting in probability P=0.148148. Candidates with the next-highest probability satisfy either of user ID=0 set to tID=0 or user ID=1 set to tID=1, resulting in probability P=0.037-37. Candidates with the lowest probability have no setting of user ID=0 to tID=0 and no setting of user ID=1 to tID=1, resulting in probability P=0.009259.

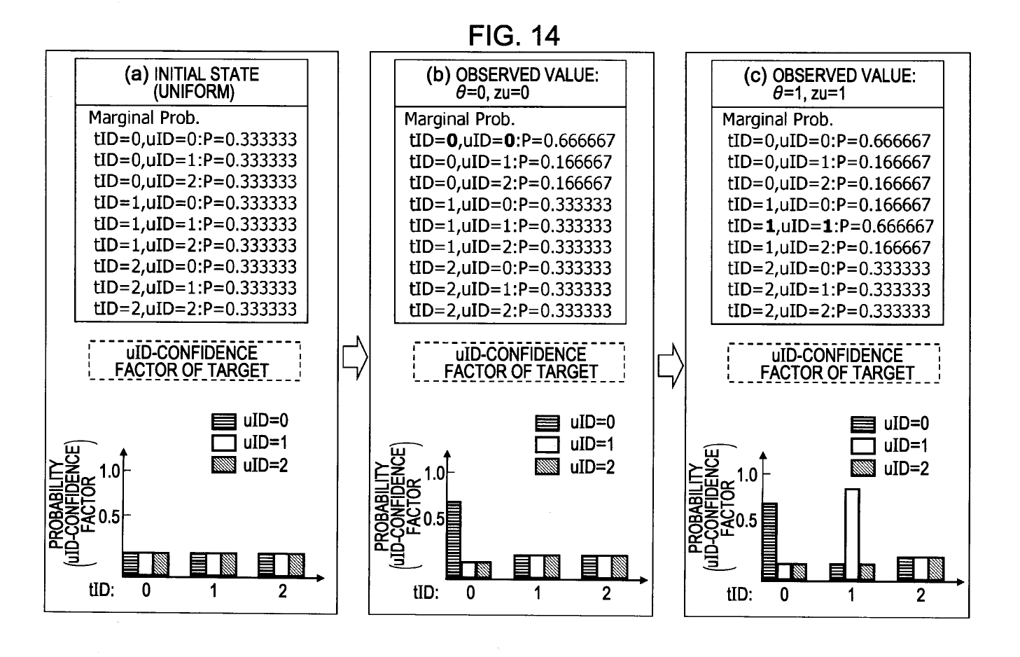

FIG. 14 illustrates the marginalized results obtained by the processing shown in FIG. 13.

(a) to (c) of FIG. 14 corresponds to those of FIG. 13, respectively. In other words, they correspond to the results (b) and (c) obtained by sequential update from the initial state (FIG. 14 (a)) on the basis of two observation information. The data shown in FIG. 14 include the following probability calculated from the results shown in FIG. 13:

probability P where tID=0 corresponds to uID=0;

probability P where tID=0 corresponds to uID=1;

. . .

probability P where tID=2 corresponds to uID=1; and

probability P where tID=2 corresponds to uID=3.

The probability shown in FIG. 14 is obtained by arithmetic addition (i.e., marginalization) of the probability values of the corresponding data from 27 different data. For example, the following formula can be applied to the calculation.

P(xuⁱ)=Σ_{Xu=xui}P(Xu)

As shown in FIG. 14 (a), in the initial state, the following probability P is uniform and is

### set to P=0.333333:

probability P where tID=0 corresponds to uID=0;

probability P where tID=0 corresponds to uID=1;

. . .

probability P where tID=2 corresponds to uID=1; and

probability P where tID=2 corresponds to uID=3.

The lower part of (a) in FIG. 14 represents graphic data of the probability.

FIG. 14 (b) represents the results of update when observation information [θ=0, zu=0] is observed. In other words, the data represents from “probability P where tID=0 corresponds to uID=0” to “probability P where tID=2 corresponds to uID=3”.

In this case, the value of “probability P where tID=0 corresponds to uID=0” is only set to high. The influence of this setting lowers the following two kinds of probability:

probability P where tID=0 corresponds to uID=1; and

probability P where tID=0 corresponds to uID=2.

In contrast, probability of other targets, tID=1 and tID=2, is not influenced at all. That is, the setting of the following probability is not changed from that of the initial state at all:

probability P where tID=1 corresponds to uID=0:

probability P where tID=1 corresponds to uID=1;

probability P where tID=1 corresponds to uID=2:

probability P where tID=2 corresponds to uID=0;

probability P where tID=2 corresponds to uID=1; and

probability P where tID=2 corresponds to uID=2.

The setting is attributable to analytical processing in which independence between targets is retained.

FIG. 14 (c) represents the results of update when observation information [θ=1, zu=1] is observed. In other words, the data represents from “probability P where tID=0 corresponds to uID=0” to “probability P where tID=2 corresponds to uID=3”.

In this case, the value of “probability P where tID=1 corresponds to uID=1” is updated to high. The influence of this update lowers the following two kinds of probability:

probability P where tID=1 corresponds to uID=0; and

probability P where tID=1 corresponds to uID=2.

The probability of other targets: tID=0 and tID2 are not influenced at all and not changed from the probability shown in (b). This originates in analytical processing that retains independence between targets.

The processing is relatively carried out by further acquisition of observation information and the sorting out of targets is then performed according to the aforementioned weights thereof, allowing a candidate with high probability to be remained. However, this processing is inefficient one because of retaining independence between the targets.

(b) Example of Analytical Processing According to an Embodiment of the Present Invention in which Independence Between Targets is Excluded

Next, an example of analytical processing according to an embodiment of the present invention in which independence between targets is excluded will be described.

In the example to be described hereinafter, the processing is performed under the constraint that same user identifier (User ID), user identification information, is not assigned to different targets.

The sound/image-integration processing unit 131 updates the simultaneous occurrence probability (joint probability) of candidate data that establishes correspondences between a target and each of users on the basis of user identification information. Here, the user identification information is an observed value included in the event information. Then, the updated value of simultaneous occurrence probability is employed to perform the calculation of a user confidence factor that corresponds to the target.

As is evident from FIG. 13 and FIG. 14, which have been described as the processing that retains independence between the targets, the independence between the targets with respect to the user identifier (User ID) may not be excluded depending on the marginalized result as shown in FIG. 14 even if the processing applied with the simultaneous occurrence probability (joint probability) is performed.

In other words, for example, in spite of resulting in an extremely high possibility of that a user corresponding to target ID: tID=0 is a “user 0” as a result in FIG. 14 (b), any processing that reflects such a result is not performed on target ID: tID=1, 2. This is because the processing retains independence between targets.

On the basis of the determination that an extremely high possibility of that target ID: tID=0 is the user 0, it is possible to estimate that target ID: tID=1, 2 is not the user 0. Thus, this estimation may be used for the update of the user confidence factor of each target to allow the processing to be efficiently performed.

Now, an example of processing for an efficient analysis with high accuracy while excluding independence between targets will be described below.

The aforementioned formula (formula 5) that corresponds to user identification information (User ID):

P(Xuₜ|θₜ,zuₜ,Xuₜ₋₁) (formula 5)

is developed using Bayes' theorem to obtain the following formula (formula 7):

$$\begin{matrix}P ( {Xu}_{t} \vert {θ}_{t} , {zu}_{t} , {Xu}_{t - 1} ) = \frac{P ( {θ}_{t} , {zu}_{t} , {Xu}_{t - 1} \vert {Xu}_{t} ) P ( {Xu}_{t} )}{P ( {θ}_{t} , {zu}_{t} , {Xu}_{t - 1} )} \\ = \frac{\begin{matrix}P ( {θ}_{t} , {zu}_{t} \vert {Xu}_{t} ) \\ P ( {Xu}_{t - 1} \vert {Xu}_{t} ) P ( {Xu}_{t} )\end{matrix}}{P ( {θ}_{t} , {zu}_{t} ) P ( {Xu}_{t - 1} )} …\end{matrix} \qquad ( formula 7 )$$

If it is assumed that only P(θₜ, zuₜ) is uniform in the formula (formula 7), then the formula (formula 5) can be represented as follows:

P(Xuₜ|θₜ,zuₜ,Xuₜ₋₁) (formula 5)

=P(θₜ,zuₜ|Xuₜ)P(Xuₜ₋₁|Xuₜ)P(Xuₜ)/P(θₜ,zuₜ)P(Xuₜ₋₁) (formula 7)

˜P(θₜ,zuₜ|Xuₜ)P(Xuₜ₋₁|Xuₜ)P(Xuₜ)/P(Xuₜ₋₁)
where “˜” means “proportional to”.

Therefore, the formula (formula 5) and the formula (formula 7) can be represented as the following formula (formula 11):

P(Xuₜ|θₜ,zuₜ,Xuₜ₋₁) (formula 5)

=R×P(θₜ,zuₜ|Xuₜ)P(Xuₜ₋₁|Xuₜ)P(Xuₜ)/P(Xuₜ₋₁) (formula 11)

where R represents a regularization term.

Furthermore, in the formula (formula 11), the limitation of that “the same user identifier (User ID) are not allocated to plural targets” is represented using prior probability P(Xuₜ) and P(Xuₜ₋₁) as follows:

limitation 1: the probability is set to P(Xuₜ)=P(Xuₜ₋₁)=NG(P=0.0) and P(Xuₜ)=P(Xuₜ₋₁)=NG(P=0.0) if there is at least one xu (user identifier (User ID)) coincided with another one in P(Xu)=P(xu¹, xu², . . . , xuⁿ), and, in other cases, P(Xuₜ)=P(Xuₜ₋₁)=OK (0.0<P≦1.0).
The settings of these kinds of probability are performed.

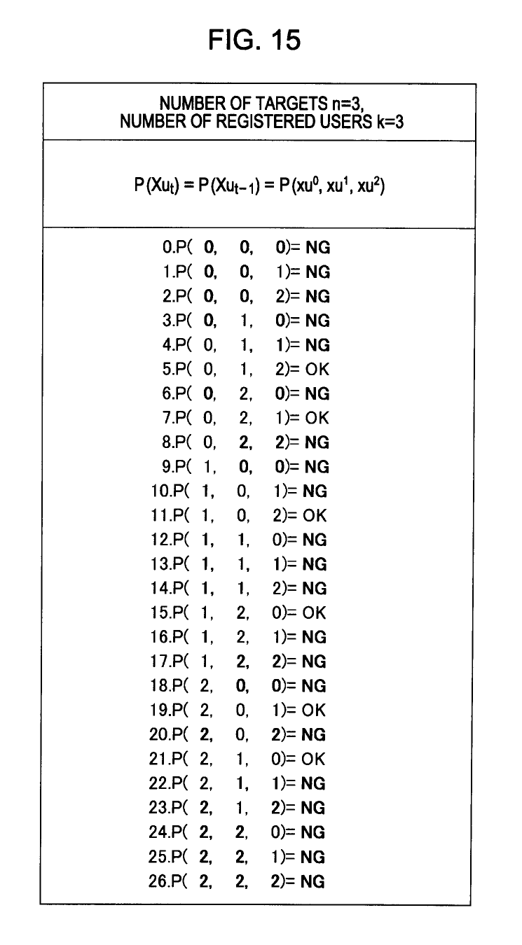

FIG. 15 illustrates an example of initial-state setting according to the above limitation when the number of targets is n=3 (0 to 2) and the number of registered users is k=3 (0 to 2).

This initial state corresponds to the initial state of (a) in FIG. 13. In other words, it represents simultaneous occurrence probability (joint probability) with respect to data corresponding to all the user IDs (0 to 2) for all the target IDs (2, 1, 0).

In the example shown in FIG. 15, simultaneous occurrence probability P is set to P=0 (NG) if there is at least one xu (user identifier (User ID) coincided with another one in P(Xu)=P(xu¹ xu², . . . , xuⁿ). To any of candidates with P=OK other than those with P=O (NG), provability values (0.0<P≦1.0) larger than zero are provided as simultaneous occurrence probability: P.

In this way, the sound/image-integration processing unit 131 performs the initial setting of simultaneous occurrence probability (joint probability) of candidate data that allows the targets to correspond to the respective users. Here, such initial setting is based on the limitation of that the same user identifier (User ID) is not allocated on plural targets.

The probability value of the simultaneous occurrence probability P(xu) of candidate data where the same user identifier (User IF) is set to different targets is P(Xu)=0.0, and

the probability value of other target data is P(xu)=0.0<P≦1.0.

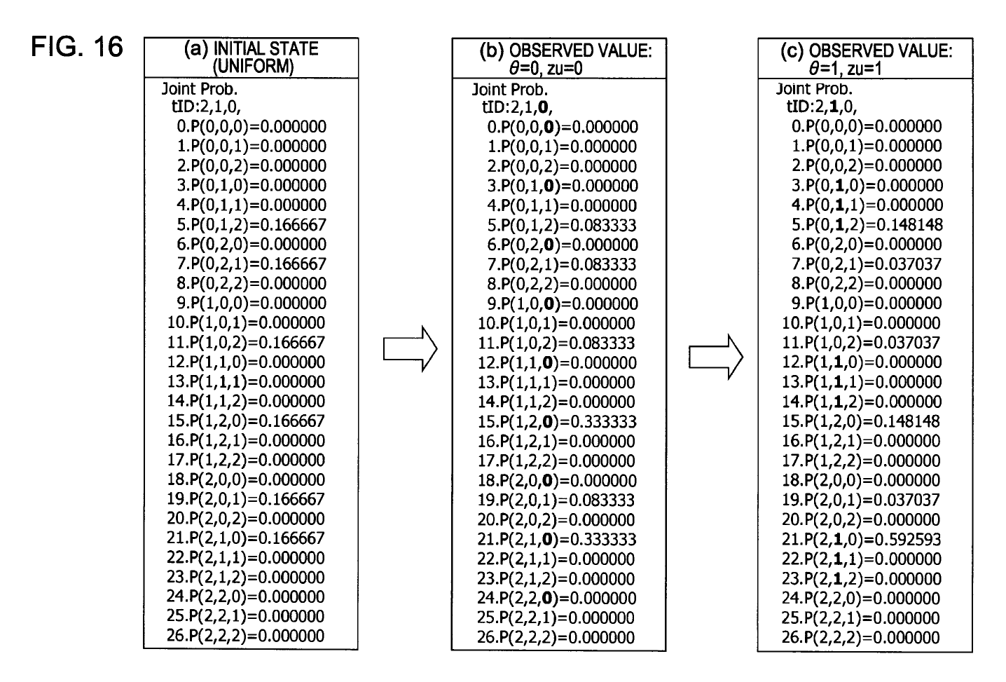

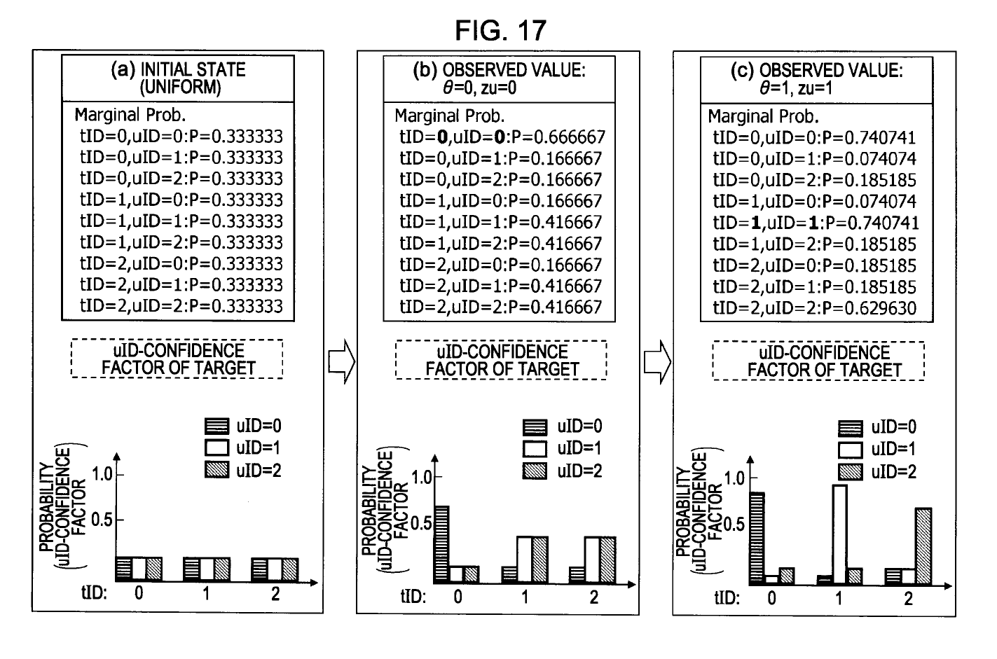

FIG. 16 and FIG. 17 illustrate an example of analytical processing according to an embodiment of the present invention. The processing of this embodiment excludes independence between targets and employs the limitation of that “the same user identifier (User ID) is not allocated to plural targets”. Here, these figures correspond to FIG. 13 and FIG. 14 that illustrate the example of the aforementioned processing retaining independence between targets.

Here, the exemplary processing shown in FIG. 16 and FIG. 17 is one that excludes independence between targets. This processing employs the formula (formula 11) generated on the basis of the formula (formula 5) corresponding to the aforementioned user identification information (User ID). The formula 11 is represented as follows:

P(Xuₜ|θₜ,zuₜ,Xuₜ₋₁) (formula 5)

=R×P(θₜ,zuₜ|Xuₜ)P(Xuₜ₋₁|Xuₜ)P(Xuₜ)/P(Xuₜ₋₁) (formula 11)

The processing is executed using the above formula and under the limitation of that the same user identifier (User ID), user identification information, is not allocated to different targets.

That is, in the above formula (formula 11), probability is set to P(Xuₜ)=P(Xuₜ₋₁)=NG(P=0.0) if there is at least one xu (user identifier (User ID) coincided with another one in P(Xu)=P(xu¹, xu², . . . , xuⁿ). In other cases, probability is set to P(Xuₜ)=P(Xuₜ₋₁)=OK(0.0<P≦1.0).

Thus, the processing with these kinds of the probability is executed.

The aforementioned formula (formula 11) is different from the formula (formula 10) used in FIG. 13 and FIG. 14 illustrating the exemplary processing retaining the independence between the targets. The formula (formula 10) is represented as follows:

P(Xuₜ|θₜ,zuₜ,Xuₜ₋₁) (formula 5)

=R×P(θₜ,zuₜ|Xuₜ)P(Xuₜ₋₁|Xuₜ) (formula 10)

The formula (formula 11) can be represented as follows:

P(Xuₜ|θₜ,zuₜ,Xuₜ₋₁) (formula 5)

=R×P(θₜ,zuₜ‥Xuₜ)P(Xuₜ₋₁|Xuₜ)P(Xuₜ)/P(Xuₜ₋₁) (formula 11)

R×(formula 8)×(formula 9)×(P(Xuₜ)/P(Xuₜ₋₁))

The exemplary processing shown in FIG. 16 and FIG. 17 are provided with the same conditional settings as those of the exemplary processing previously described with reference to FIG. 13 and FIG. 14, except for the setting of P=0 (NG) if there is at least one xu (user identifier (User ID) coincided with another one in P(Xu)=P(xu¹, xu², . . . , xuⁿ)

In other words, in [prior probability P] represented by the above formula (formula 8), P(θₜ, zuₜ|Xuₜ)=P(θₜ, zuₜ|xuₜ¹, xuₜ², . . . , xuₜθ, . . . , xuₜⁿ), the probability is set to as follows:

prior probability: P=A=0.8 when the prior probability P of an observed value is xuₜθ=zuₜ, and

prior probability: P=B=0.2 in other cases.

Furthermore, in [state transition probability P] represented by the above formula (formula 8), P(Xuₜ₋₁|Xuₜ), the probability is set to as follows:

state transition probability P=C=1.0 when there is no change in user identifier (User ID) with respect to all the targets at time t and time t−1, and

state transition probability P=D=0.0 in other cases.

FIG. 16 and FIG. 17 illustrate an example of variations in the probability values, user confidence factors (uID), of user IDS (0 to 2) for target IDs (2, 1, 0) when a series of observation information is observed in order under the above probability setting at two observation times,

“θ=0, zu=0” and

“θ=1, zu=1”.

The user confidence factors are calculated as simultaneous occurrence probability (joint probability) with respect to data corresponding to all the user IDs (0 to 2) for all the target IDs (2, 1, 0).

As described above, “θ=0, zu=0” indicates that the observation information [zu] corresponding to the user identifier (UID=0) from the target (θ=0).

“θ=1, zu=1” indicates that the observation information [zu] corresponding to the user identifier (UID=1) from the target (θ=1).

Candidates of user IDs (uID=0 to 2) corresponding to three target IDS (tID=0, 1, 2) are tID0, 1, and 2=(0, 0, 0) to (2, 2, 2) as shown in the column of (a) Initial state shown in FIG. 16.

There are 27 different candidate data.

Simultaneous occurrence probability (joint probability) is calculated for each of these 27 different candidate data as an user confidence factor corresponding to all the user IDs (0 to 2) for all the target IDs (2, 1, 0).

Probability (user confidence factor) is different from that of (a) Initial state in FIG. 13 as described above. That is, the probability is set to P=0 if there is one xu (user identifier (User ID)) coincided with another one. In the example shown in the figure, for example, a probability value of P=0.166667 is set to other candidates.

In FIG. 16, (b) represents, when observation information [θ=0, zu=0] is observed, variations of user confidence factors (confidence factors of all the user IDs (0 to 2) corresponding to all the target IDs (2, 1, 0)) calculated as simultaneous occurrence probability (joint probability).

The observation information [θ=0, zu=0] is one in which the observation information from target ID=0 corresponds to user ID=0.

Based on the observation information, from 27 candidates except of other candidates set with P=0 (NG) in the initial state, the probability P (simultaneous occurrence probability (joint probability)) of candidate data in which user ID=0 is set to tID=0 is increased, while the probability P of others is lowered.

Among candidates set with probability P=0.166667 in the initial state, the probability P of the candidate with user ID=0 set to tID=0 is heightened and set to P=0.333333, while the probability of any of other candidates is lowered to P=0.0083333.

In FIG. 16, furthermore, (c) represents, when observation information [θ=1, zu=1] is observed, variations of user confidence factors (coincidence factors of all the user IDs (0 to 2) corresponding to all the target IDs (2, 1, 0)) calculated as simultaneous occurrence probability (joint probability).

The observation information [θ=1, zu=1] is one in which the observation information from target ID=1 corresponds to user ID=1.

Based on the observation information, from 27 candidates except of other candidates set with P=0 (NG) in the initial state, the probability P (simultaneous occurrence probability (joint probability)) of candidate data in which user ID=1 is set to target ID=1 is increased, while the probability P of others is lowered.

As shown in FIG. 16 (c), the results can be classified into four different probability values.

Candidates with the highest probability is not set to P=0 (NG) in the initial state but set to tID=0 for user ID=0 and tID=1 for user ID=1. The simultaneous occurrence probability of these candidates is P=0.592593.

Candidates with the next-highest probability is not set to P=0 (NG) and satisfy either of user ID=0 set to tID=0 or user ID=1 set to tID=1. The simultaneous occurrence probability of these candidates is P=0.148148.

Candidates with the third highest probability is not set to P=0 (NG), user ID=0 is not set to tID=0 and user ID=1 is not set to tID=1. The simultaneous occurrence probability of these candidates is P=0.037037.

Candidates with the lowest probability is set to P=0 (NG) in the initial state. The simultaneous occurrence probability of these candidates is P=0.0.

FIG. 17 illustrates the marginalized results obtained by the processing shown in FIG. 16.

(a) to (c) in FIG. 17 correspond to those of FIG. 16, respectively. In other words, they correspond to the results (b) and (c) obtained by sequential update from the initial state (FIG. 17 (a)) on the basis of two kinds of observation information. The data shown in FIG. 17 include the following probability calculated from the results shown in FIG. 16:

probability P where tID=0 corresponds to uID=0;

probability P where tID=0 corresponds to uID=1;

. . .

probability P where tID=2 corresponds to uID=1; and

probability P where tID=2 corresponds to uID=3.

The probability shown in FIG. 17 is obtained by arithmetic addition (i.e., marginalization) of the probability values of the corresponding data from 27 different data listed in FIG. 16. For example, the following formula can be applied to the calculation.

P(xuⁱ)=Σ_{Xu=xui}P(Xu)

As shown in FIG. 17 (a), in the initial state, the following probability P is uniform and is set to P=0.333333:

probability P where tID=0 corresponds to uID=0;

probability P where tID=0 corresponds to uID=1;

. . .

probability P where tID=2 corresponds to uID=1; and

probability P where tID=2 corresponds to uID=3.

The lower panel of (a) in FIG. 17 represents graphic data of the probability.

The results obtained in the initial state are similar to those previously descried in FIG. 14 (a) with reference to the exemplary processing that retains independence of the respective targets.

FIG. 17 (b) represents the results of update when observation information [θ=0, zu=0] is observed. In other words, the data represents from “probability P where tID=0 corresponds to uID=0” to “probability P where tID=2 corresponds to uID=3”.

In this case, the value of “probability P where tID=0 corresponds to uID=0” is only set to high. The influence of this setting lowers the following two kinds of probability:

probability P where tID=0 corresponds to uID=1; and

probability P where tID=0 corresponds to uID=2.

Furthermore, in the present processing example, with respect to tID=1, probability of uID=0 decreases;

probability P of uID=1 increases; and

probability P of uID=2 increases.

With respect to tID=2,

probability P of uID=0 decreases;

probability P of uID=1 increases; and

probability P of uID=2 increases.

Therefore, there is a change in probability (user confidence factor) of targets (tID=1, 2) which is different from a target (tID=0) assumed to have acquired the observation information “θ=0, zu=0”.

This fact makes a difference from the fact observed in FIG. 14 (b). That is, in FIG. 14 (b), the update is performed to change the probability of the data of tID=0, while leaving that of tID=1, 2 as it is. In contrast, in FIG. 17 (b), all the data of tID=0, 1, 2 are updated.

The processing which has been described above with reference to FIGS. 13 and 14 is an example of the processing that retains independence of the respective targets. In contrast, the processing shown in FIG. 16 and FIG. 17 is an example of the processing that excludes the independence of the respective targets. In other words, one observation data effects not only on one target-corresponding data but also another target-corresponding data.

In the example of the processing of FIG. 16 and FIG. 17, in the formula (formula 11):

P(Xuₜ|θₜ,zuₜ,Xuₜ₋₁) (formula 5)

=R×P(θₜ,zuₜ|Xuₜ)P(Xuₜ₋₁|Xuₜ)P(Xuₜ)/P(Xuₜ₋₁) (formula 11),

probability is set to P(Xuₜ)=P(Xuₜ₋₁)=NG(P=0.0) if there is limitation 1 that at least one xu (user identifier (User ID) is coincided with another one in P(Xu)=P(xu¹, xu², . . . xuⁿ) and, in other cases, set to P(Xuₜ)=P(Xuₜ₋₁)=OK(0.0<P≦1.0).

As a result of the processing, as shown in FIG. 17 (b), the probability (user confidence factor) of the target (tID=0) assumed to have acquired the observation information “θ=0, zu=0” and that of any of other targets (tID=2, 3) are charged. Thus, probability (user confidence factor) representing which user each target corresponds can be efficiently updated with high precision.

FIG. 17 (c) represents the results of update when observation information [θ=1, zu=1] is observed. In other words, the data represents from “probability P where tID=0 corresponds to uID=0” to “probability P where tID=2 corresponds to uID=3”.

In this case, the update is performed so that the value of “probability P where tID=1 corresponds to uID=1” is set to high. The influence of the update lowers the following two kinds of probability:

probability P where tID=1 corresponds to uID=0; and

probability P where tID=1 corresponds to uID=2.

Furthermore, in the present processing example, with respect to tID=0, probability of uID=0 increases;

probability P of uID=1 decreases; and

probability P of uID=2 increases.

With respect to tID=2,

probability P of uID=0 increases;

probability P of uID=1 decreases; and

probability P of uID=2 increases.

Therefore, there is a change in probability (user confidence factor) of targets (tID=0, 2) which is different from a target (tID=1) assumed to have acquired the observation information “θ=1, zu=1”.

In the processing example which has been described with reference to FIGS. 15 to 17, the update processing are performed on all the target data using a limitation, such as limitation 1: the probability is set to P(Xuₜ)=P(Xuₜ₋₁)=NG(P=0.0) if there is at least one xu (user identifier (User ID) coincided with another one in P(Xu)=P(xu¹, xu², . . . , xuⁿ) and, in other cases, set to P(Xuₜ)=P(Xuₜ₋₁)=OK(0.0<P≦1.0). In this embodiment, the update processing is performed on all the target data using such a limitation. However, the present invention is not limited to such a limitation. Alternatively, the processing may be designed as follows.

In P(Xu)=P(xu¹, xu², . . . , xuⁿ), the state where at least one xu (user identifier (User ID)) is coincident with another one is deleted from target data. Then, the process is executed only on the remaining target data. Such processing allows the state number of [Xu] to be reduced from kₙ to ₙPₖ. Therefore, it becomes possible to enhance the efficiency of the processing.

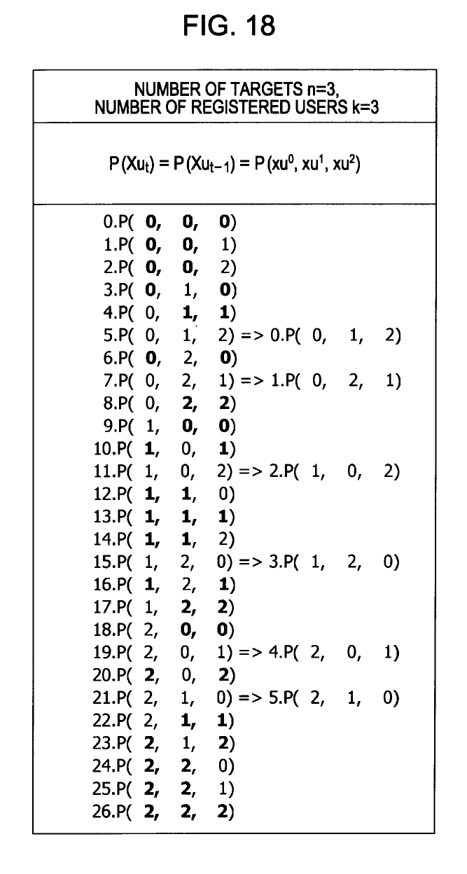

An example of data-deleting processing will be described with reference to FIG. 18. For example, there are 27 different candidates of user IDs (uID=0 to 2) corresponding to three target IDs (tID=0, 1, 2), tID 0, 1, 2=(0, 0, 0) to (2, 2, 2), represented on the left side of FIG. 18. In the data of these 27 candidates [P(Xu)=P(xu¹, xu², xu³)], the state of the presence of at least one xu (user identifier (User ID)) coincided with another one is removed from target data, thereby resulting in six data, 0 to 5, represented on the right side of FIG. 18.

Alternatively, the sound/image-integration processing unit 131 may be designed to execute processing in which candidate data with the same user identifier (User ID) set to different targets is deleted as described above and the rest of data is left as it is and only the remaining candidate data is provided as an update subject on the basis of event information.

Even if the processing is executed only on these six data as update subject, the same results as those described with reference to FIG. 16 and FIG. 17 can be obtained. (c) An example of analytical processing that gives consideration to the presence of an unregistered user in an example of analytical processing according to an embodiment of the present invention in which independence between targets is excluded

Next, an processing example will be described in consideration of the presence of an unregistered user in the above-described [(b) an example of analytical processing according to an embodiment of the present invention in which independence between targets is excluded].

In the above-described [(b) an example of analytical processing according to an embodiment of the present invention in which independence between targets is excluded], the processing is executed with respect to each of “k” registered users 1 to k when the number of registered users is “k” while setting their respective user identifiers (uID) to uID=1 to k.

However, in the actual processing, unregistered user's images and sounds other than those of registered users may be sometimes acquired as observation information. The number of the unregistered users may be one or two or more. In other words, unlike the registered users, the number of the unregistered user may not be specified in advance.

Furthermore, in general, identification devices (such as a face-identification device and a speaker identification device) may not distinguish different unregisters. In this case, a user identifier may not be analyzed. In other words, the identification device only outputs the same observed value, “user ID=unknown”.

In this case, in limitation 1 defined in the aforementioned [(b) an example of analytical processing according to an embodiment of the present invention in which independence between targets is excluded], i.e., limitation 1: in P(Xu)=P(xu¹, xu², . . . , xuⁿ), if there is at least one xu (User ID) coincided with another one, the probability is P(Xuₜ)=P(Xuₜ₋₁)=NG (0.0) and, in other cases, P(Xuₜ)=P(Xuₜ₋₁)=OK(0.0<P≦1.0), the direct application of limitation 1 leads to an undesired result.

In other words, a plurality of unregistered users will be generated. If the unregistered users are considered as the same user (unknown), a case in which a plurality of identical user identifiers (uID=unknown) coincided with one another in the above limitation is set to P(Xuₜ)=P(Xuₜ₋₁)=NG (0.0). Thus, such a state which may actually not occur will be ignored.

Therefore, an exceptional rule is added to the above limitation 1. In other words, limitation 1 is defined as follows:

In P(Xu)=P(xu¹, xu², . . . , xuⁿ), if there is at least one xu (User ID) coincided with another one, the probability is P(Xuₜ)=P(Xuₜ₋₁)=NG (0.0) and, in other cases, P(Xuₜ)=P(Xuₜ₋₁)=OK(0.0<P≦1.0), but there is an exception that limitation 1 is not applied if xu=unknown.

The use of such a limitation with an exception allows application of the aforementioned [(b) an example of analytical processing according to an embodiment of the present invention in which independence between targets is excluded] even in an environment in which an unregistered user may occur.

### [Deletion and Generation Processing of Targets]

For example, when the number of events inputted from the image-event detecting unit 112 is higher than the number of targets, the setting of new targets is performed. Specifically, for example, such a case corresponds to one in which a face which has not been present emerges on an image frame to be shot by a camera or the like. In this case, a new target is set to each particle. This target is designed as one to be updated corresponding to the new event. In addition, for example, processing for deleting data such as one, which has not been provided with a specific user position, may not be executed in the case of detecting no peak of user position information included in the target.

Therefore, in the present system, the number of targets may be increased or decreased when the deletion or generation of targets is performed. Depending on such an increase or decrease in number of targets, state [Xu] also varies. Thus, there is a request of recalculating the probability values. Hereinafter, specific examples of processing for target deletion and target generation will be described.

(Target Deletion)

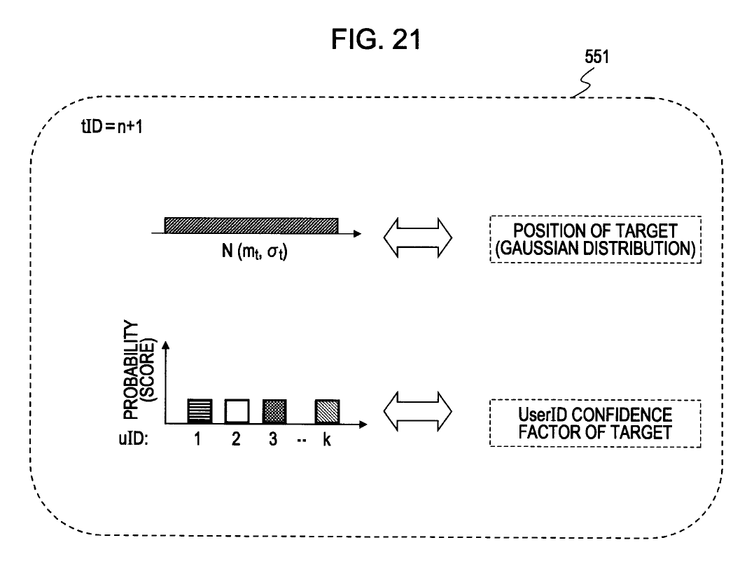

In the information processing apparatus according to the embodiment of the present invention, the sound/image-integration processing unit 131 performs processing for generating target information on the basis of the target data updated by execution of the update of the target data and the respective particle weights [W_{pID}] and outputting the target information to the processing determining unit 132. The sound/image-integration processing unit 131 generates, for example, target information 520 shown in FIG. 21. The target information is generated as information including (a) user position information and (b) user confidence factor information of the respective targets (tID=1 to n).

The sound/image-integration processing unit 131 pays attention to the user position information in the target information generated on the basis of the updated targets in this way. The user position information is set as a Gaussian distribution N(m, σ). When a fixed peak is not detected in the Gaussian distribution, the user position information is not effective information indicating a position of a specific user. The sound/image-integration processing unit 131 selects a target with such distribution data not having a peak as a deletion object.

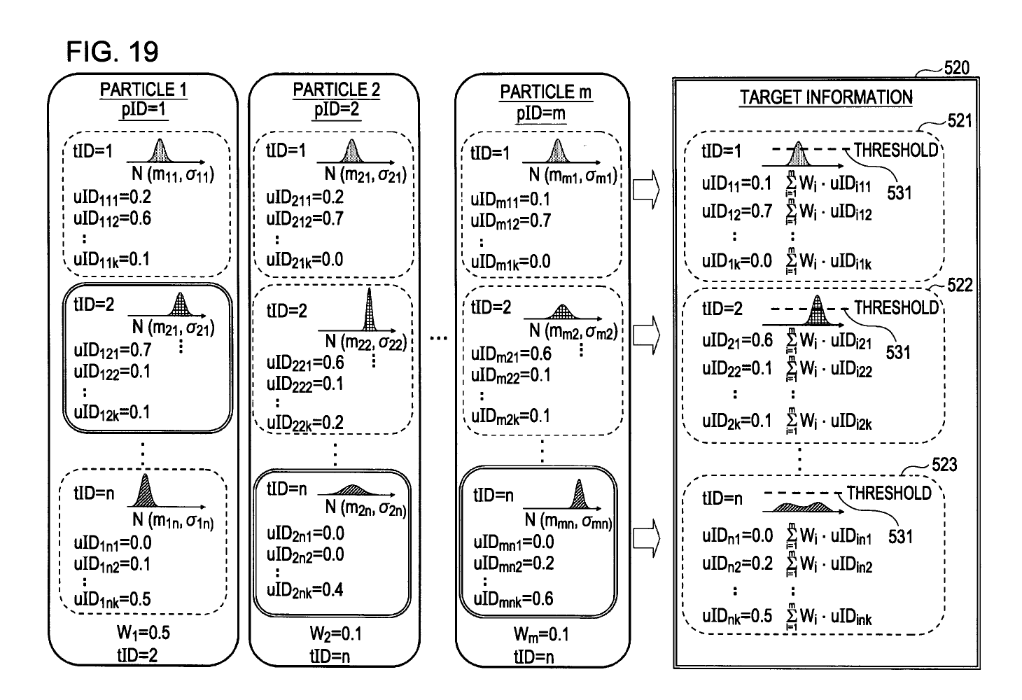

For example, in the target information 520 shown in FIG. 19, three kinds of target information 521, 522, and 523 of targets 1, 2, and n are shown. The sound/image-integration processing unit 131 executes comparison of peaks of Gaussian distribution data indicating user positions in the target information and a threshold 531 set in advance. The sound/image-integration processing unit 131 sets data not having a peak equal to or higher than the threshold 531, i.e., in an example in FIG. 19, the target information 523 as a deletion target.

In this example, a target (tID=n) is selected as a deletion target and deleted from the particles. When a maximum of a Gaussian distribution (a probability density distribution) indicating a user position is smaller than the threshold for deletion, a target with the Gaussian distribution is deleted from all the particles. The applied threshold may be a fixed value or may be changed for each target, for example, set lower for an interaction object target to prevent the interaction object target from being easily deleted.

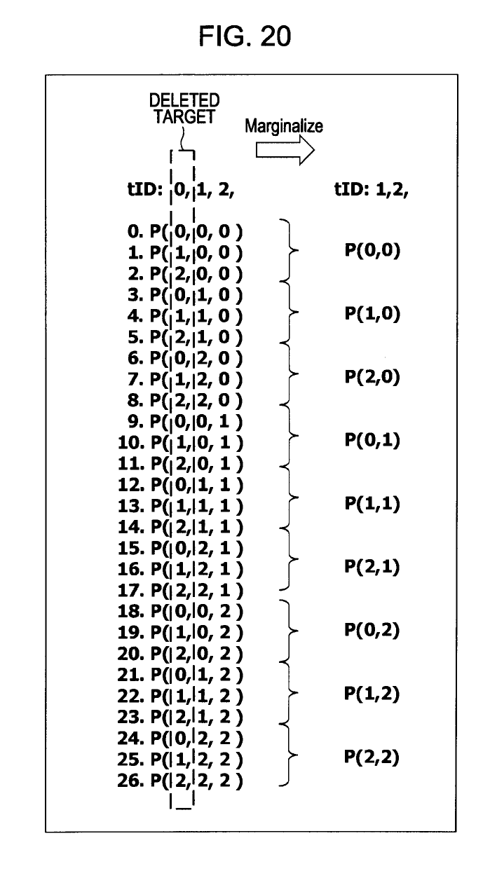

In this way, when a certain target is deleted, the probability value of the target is marginalized. An example of deleting a target (tID=0) from three targets (tID=0, 1, 2) is illustrated in FIG. 20.

In the column on the left side of FIG. 20, an example of setting 27 kinds of target data, 0 to 26, as candidate data of uIDs corresponding to three targets (tID=0, 1, 3) are listed. When the target 0 is deleted from these target data, as shown in the column on the light side of FIG. 20, the data is marginalized into nine kinds of data, nine combinations (0, 0) to (2, 2) of tID=1, 2. In this case, from 27 data before marginalization, the respective data combinations (0, 0) to (2, 2) of tID=1, 2 are selected to generate nine kinds of data after marginalization. For example, one combination tID=1, 2=(0, 0) is generated from three data of tID=(0, 0, 0), (1, 0, 0), and (2, 0, 0).

Here, distribution of probability values in the processing for deleting the target data will be described.

For example, one combination tID=1, 2=(0, 0) is generated from three data of tID=(0, 0, 0), (1, 0, 0), and (2, 0, 0). Probability values P set with three data of tID=(0, 0, 0), (1, 0, 0), and (2, 0, 0) is marginalized and set to probability value for tID=1, 2=(0, 0).

Therefore, when deleting a target, the sound/image-integration processing unit 131 executes processing by which the value of simultaneous occurrence probability set to candidate data including the deleting target is marginalized to candidate data being remained after the deletion of the target. Subsequently, the sound/image-integration processing unit 131 executes processing for normalizing the value of simultaneous occurrence probability set to all the candidate data to 1 (one).

(Target Generation)

Processing for generating a new target in the sound/image-integration processing unit 131 will be described with reference to FIG. 21. The generation of a new target is performed, for example, when event occurrence source hypotheses are set for the respective particles.

In calculating an event-target likelihood between an event and respective existing n targets, the sound/image-integration processing unit 131 provisionally generates, as n+1th target, a new provisional target 551 with “position information” and “identification information” set in uniform distributions (“a Gaussian distribution with a sufficiently large variance” and “a User ID distribution in which all Pt[i]s are equal”) as shown in FIG. 21.

After setting the provisional new target (tID=n+1), the sound/image-integration processing unit 131 performs the setting of event occurrence source hypotheses on the basis of an input of a new event. In this processing, the sound/image-integration processing unit 131 executes calculation of a likelihood between input event information and the respective targets and calculates target weights [W_{tID}] of the respective targets. In this case, the sound/image-integration processing unit 131 also executes the calculation of a likelihood between the input event information and the provisional target (tID=n+1) shown in FIG. 21 and calculates a target weight (Wₙ₊₁) of a provisional n+1th target.

When it is judged that the target weight (Wₙ₊₁) of the provisional n+1th target is larger than target weights (W₁ to Wₙ) of the existing n targets, the sound/image-integration processing unit 131 sets the new target for all the particles.

When a new target is generated, data with respect to the new target is added to a certain state and the states corresponding to the number of users is allocated to the additional data and the probability value thereof is distributed to the existing target data.

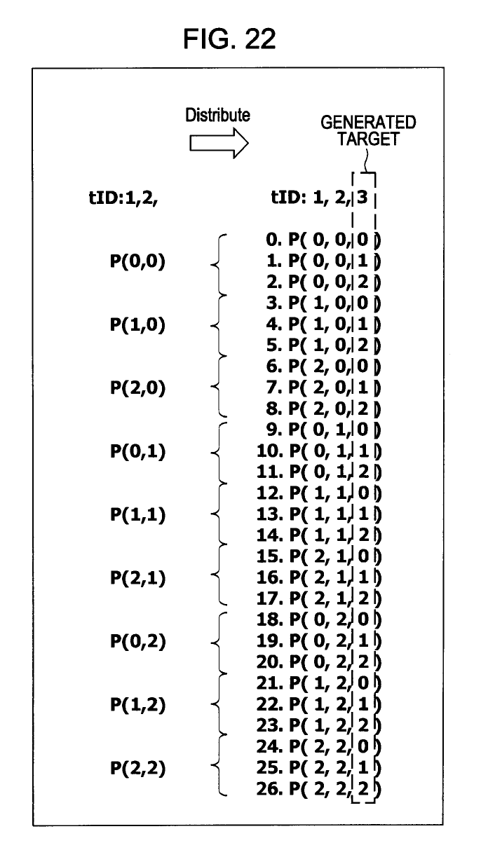

FIG. 22 illustrates an example of processing that a target (tID=3) is newly generated and added to two targets (tID=1, 2).

In a column of the left side of FIG. 22, nine kinds of data are listed as target data (0, 0) to (2, 2) that represent the candidates of uIDs corresponding to two targets (tID=1, 2). To the target data, additional target data set with a new user of user identifier k=3 is added. This processing allows the stetting of 27 kinds of target data (0 to 26) listed on the right side of FIG. 22.

The distribution of probability values in the processing for increasing the target data will be now described.

For example, three data of tID=(0, 0, 0), (0, 0, 1), (0, 0, 2) are generated from tID=1, 2=(0, 0). Probability values P set to tID=1, 2=(0, 0) are uniformly distributed to these three data [tID=(0, 0, 0), (0, 0, 1), (0, 0, 2)].

In addition, when processing according a limitation, such as one in which “the same user ID is not assigned to plural targets” is performed, the corresponding prior probability and the number of states are decreased. In addition, when the total probability of the respective target data is not [1], or the total simultaneous occurrence probability (joint probability) is not [1], normalization processing is performed to adjust the total to [1].

Therefore, when a new target is generated and added to the existing targets, the sound/image-integration processing unit 131 executes processing for allocating states corresponding to the number of users to the additional candidate data provided by the addition of the generated target, and distributing the value of the simultaneous occurrence probability set to the existing candidate data to the additional candidate data. Subsequently, the sound/image-integration processing unit 131 executes processing for normalizing the total value of the simultaneous occurrence probability set to all the candidate data to 1 (one).

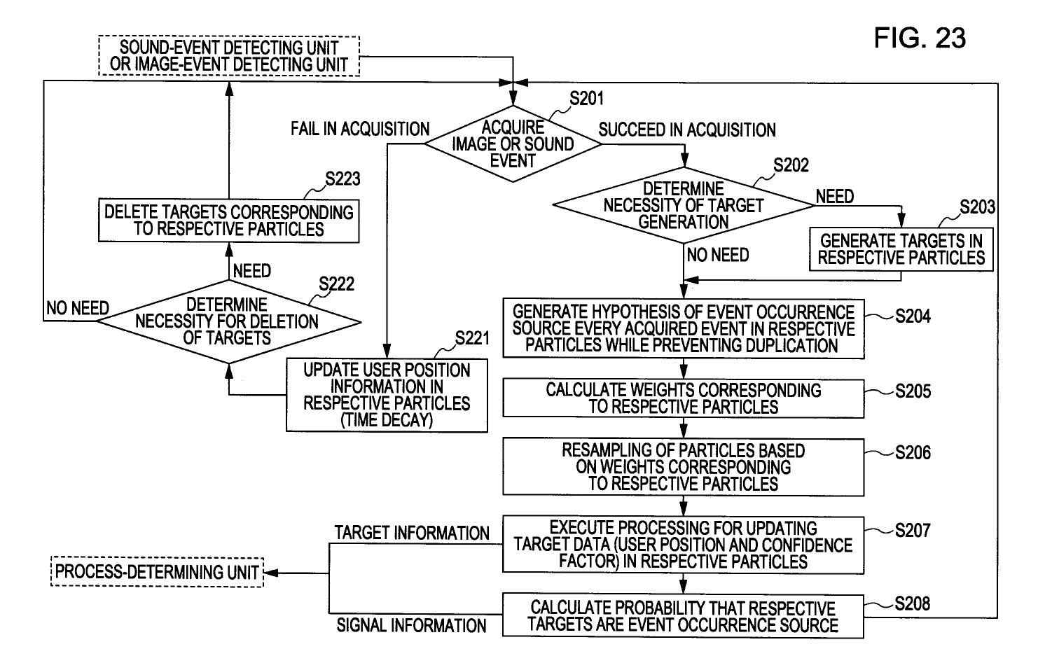

Referring now to the flowchart illustrated in FIG. 23, a processing sequence when the analytical processing with exclusion of independence between targets is performed will be described.

The processing shown in FIG. 23 is a processing sequence. That is, the sound/image-integration processing unit 131 in the information processing apparatus 100 shown in FIG. 2 receives inputs of event information from the sound event detecting nit 122 and the image-event detecting unit 112. Here, the event information includes two kinds of information shown in FIG. 3B, user position information and user identification information (face identification information or speaker identification information). Then, the sound/image-integration processing unit 131 responds to the inputs to output the following information to the processing determining unit 132:

(a) [Target information] as estimation information indicating where the plural users are present, respectively, and who are the users; and
(b) [signal information] indicating an event occurrence source such as a user who spoke.

First, in step S201, the sound/image-integration processing unit 131 receives inputs of the following information from the sound-event detecting unit 122 and the image-event detecting unit 112:

(a) user position information;
(b) user identification information (face identification information or speaker identification information); and
(c) face-attribute information (face-attribute score).

The process proceeds to step S202 when it succeeds in acquisition of event information or proceeds to step S221 when it fails in acquisition of event information. The processing in step S221 will be described later.

If the acquisition of event information is succeeded, then the sound/image-integration processing unit 131 executes processing for updating particles based on input information in step S202 and the subsequent steps thereof. In step S202, before the processing for updating particles, it is determined whether there is a request of setting a new target for each particle.

For example, if the number of events input from the image event detecting unit 112 is higher than the number of targets, then there is a request of setting a new target. Specifically, it is desirable when a new face which has not been present in an image frame taken by a camera is appeared. In this case, the process proceeds to step S203 to set a new target to each particle. The target is defined as one to be updated corresponding to the new event. Furthermore, when generating the new target data, as described with reference to FIG. 20, the data for the new target is incremented for a certain state and the states corresponding to the number of users are allocated to the incremented data. Subsequently, process for setting probability values is performed to distribute the probability value to the existing target data.

Next, in step S204, hypotheses of an event occurrence source are set to the respective m particles 1 to m (pID=1 to m) which are set in the sound/image-integration processing unit 131. The event occurrence source is, for example, in the case of a sound event, a user who spoke and, in the case of an image event, a user who has an extracted face.

After the setting of hypotheses in step S204, the process exceeds to step S205. In the step S205, the sound/image-integration processing unit 131 calculates weighs corresponding to the respective particles, i.e., particle weights [W_{pID}]. As the particle weights [W_{pID}], as described above, a uniform value is initially set for the respective particles but is updated according to an event input.

Details of processing for calculating a particle weight [W_{pID}] have been already described above with reference to FIGS. 9 and 10. The particle weight [W_{pID}] are equivalent to an index for judging correctness of hypotheses of the respective particles for which hypothesis targets of an event occurrence source are generated. The particle weight [W_{pID}] is calculated as an event-target likelihood that is a similarity between the hypothesis targets of an event occurrence source set for the respective m particles (pID=1 to m) and an input event.

Subsequently, in step S206, the sound/image-integration processing unit 131 executes processing for re-sampling particles on the basis of the particle weights [W_{pID}] of the respective particles set in step S205.

The particle re-sampling processing is executed as processing for selecting particles out of the m particles according to the particle weight [W_{pID}].

Specifically, when the number of particles m is 5, particle weights are set as follows:

the particle 1: the particle weight [W_{pID}]=0.40;
the particle 2: the particle weight [W_{pID}]=0.10;
the particle 3: the particle weight [W_{pID}]=0.25;
the particle 4: the particle weight [W_{pID}]=0.05; and
the particle 5: the particle weight [W_{pID}]=0.20.
In this case, the particle 1 is re-sampled at a probability of 40% and the particle 2 is re-sampled at a probability of 10%. Actually, m is as large as 100 to 1000. A result of the re-sampling includes particles at a distribution ratio corresponding to weights of the particles.

According to this processing, a large number of particles with large particle weights [W_{pID}] remain. Even after the re-sampling, the total number [m] of the particles is not changed. After the re-sampling, the weights [W_{pID}] of the respective particles are reset. The processing is repeated from step S201 according to an input of a new event.

In step S207, the sound/image-integration processing unit 131 executes processing for updating target data (user positions and user confidence actors) included in the respective particles. Respective targets include, as explained above with reference to FIG. 6 and the like, the following data:

(a) user positions: a probability distribution of presence positions corresponding to the respective targets [Gaussian distribution: N(mₜ, σₜ)]; and
(b) user confidence factors: values (scores) of probabilities that the respective targets are the respective users 1 to k as the user confidence factor information (uID) indicating who the respective targets are: Pt[i](i=1 to k), i.e.,

$$\begin{matrix}{uID}_{t 1} = Pt [ 1 ] \\ {uID}_{t 2} = Pt [ 2 ] \\ ⋮ \\ {uID}_{tk} = Pt [ k ] .\end{matrix}$$

The update of the target data in step S207 is executed for each of (a) user positions and (b) user confidence factors.

First, processing for updating (a) user positions will be described.

Processing of updating (a) user positions is performed in a manner similar to that of the step S105 in the flowchart illustrated in FIG. 7 in the aforementioned [(1) Processing for finding the position of a user and identifying the user by renewal of a hypothesis based on event information input]. In other words, the update of user positions is performed as update processing at two stages:

(a1) update processing applied to all the targets of all the particles; and
(a2) update processing applied to event occurrence source hypothesis targets set for the respective particles.

(b) The processing for updating user confidence factors, the aforementioned processing using the formula (formula 11) is executed. That is, it is processing with exclusion of independence between targets and employing the formula (formula 11) generated on the basis of the corresponding formula (formula 5) as described above. The formula is represented as follows:

P(Xuₜ|θₜ,zuₜ,Xuₜ₋₁) (formula 5)

=R×P(θt,zuₜ|Xuₜ)P(Xuₜ₋₁|Xuₜ)P(Xuₜ)/P(Xuₜ₋₁) (formula 11)

Furthermore, the above formula is applied to execute the processing with a limitation of that the same user identifier (User ID), user identification information, is not allocated to different targets.

Furthermore, simultaneous occurrence probability (joint probability) which have been described with reference to FIGS. 15 to 17, or simultaneous occurrence probability for data that allows all the user IDs to be coordinated with all the targets, is calculated. Then, processing for updating simultaneous occurrence probability is executed on the basis of observed values inputted as event information to calculate user confidence factor information (uID) representing who the respective targets are.

Furthermore, as described above with reference to FIG. 17, the probability values of plural candidate data are added together, or marginalized to obtain user identifiers corresponding to the respective targets (tID). The calculation is performed using the following formula:

P(xuⁱ)=Σ_{Xu=xui}P(Xu)

The target information including the user confidence factor information and the user position information obtained as descried above is output to the processing determining unit.

In step S208, the sound/image-integration processing unit 131 calculates probabilities that the respective n targets (tID=1 to n) are event occurrence sources and outputs the probabilities to the processing determining unit 132 as signal information.

As explained above, the [signal information] indicating the event occurrence sources is, concerning a sound event, data indicating who spoke, i.e., a [speaker] and, concerning an image event, data indicating whose face a face included in an image is.

The sound/image-integration processing unit 131 calculates probabilities that the respective targets are event occurrence sources on the basis of the number of hypothesis targets of an event occurrence source set in the respective particles.

In other words, probabilities that the respective targets (tID=1 to n) are event occurrence sources are represented as P(tID=i), where, “i” is i=1 to n.

In this case, probabilities that the respective targets are event occurrence sources are calculated as follows:

P(tID=1): the number of targets to which tID=1 is allocated/m,

P(tID=2): the number of targets to which tID=2 is allocated/m,

. . . , and

P(tID=n): the number of targets to which tID=2 is allocated/m.

The sound/image-integration processing unit 131 outputs information generated by this calculation processing, i.e., the probabilities that the respective targets are event occurrence sources to the processing determining unit 132 as [signal information].

The sound/image-integration processing unit 131 returns to step S201 when the processing in step S208 is completed. Then, it shifts to a state of standby for an input of event information from the sound-event detecting unit 122 and the image-event detecting unit 112.

In the above description, steps S201 to S208 of the flow shown in FIG. 23 have been described. Even when the sound/image-integration processing unit 131 may be unable to acquire the event information shown in FIG. 3B from the sound-event detecting unit 122 or the image-event detecting unit 112 in step S221, update of data of the targets included in the respective particles is executed in step S221. This update is processing that takes into account a change in user positions according to elapse of time.

This target update processing is processing same as (a1) the update processing applied to all the targets of all the particles in the explanation of step S207. This processing is executed on the basis of an assumption that a variance of the user positions expands as time elapses. The user positions are updated by using the Kalman filter according to elapsed time from the last update processing and position information of an event.

This processing is executed in a manner similar to the processing in step S121 of the flowchart illustrated in FIG. 7 described in the aforementioned [(1) Processing for finding the position of a user and identifying the user by renewal of a hypothesis based on event information input].

If the process in Step S221 is completed, step S22 determines whether there is necessity of deleting a target. Then, if requested, the target will be deleted in Step S223. The deletion of a target is performed as processing for deleting data which has not been provided with a specific user position, for example, when no peak is detected in the user position information included in the target. If there is no such a target, then the deletion processing is not desirable.

After the processing in step S222 to S223, the sound/image-integration processing unit 131 returns to step S201 and shifts to a state of standby for an input of event information from the sound-event detecting unit 122 and the image-event detecting unit 112.

In the above description, the processing executed by the sound/image-integration processing unit 131 has been descried with reference to FIG. 23. The sound/image-integration processing unit 131 executes the processing according to the flowchart illustrated in FIG. 23 repeatedly every time event information is input from the sound-event detecting unit 122 and the image-event detecting unit 112. By repeating the processing, weights of particles with targets having higher reliabilities set as hypothesis targets increase. By performing sampling processing based on the particle weights, particles having larger weights remain.

As a result, the remaining data is one having high reliabilities similar to event information inputted from the sound-event detecting unit 122 or the image-event detecting unit 112. Finally, information having high reliabilities, i.e.,

(a) [target information] as estimation information indicating whether plural users are present, respectively, and who the users are; and
(b) [signal information] indicating an event occurrence source such as a user who spoke is generated and outputted to the processing determining unit 132.

By performing the process with exclusion of independence between targets according to the present invention, the update of data representing the user confidence factor of all the target can be performed using one observed value. Therefore, the processing for identifying users can be efficiently realized using one observed value with a high degree of precision.

The present invention has been described in detail with reference to the specific embodiment. However, it is obvious that those skilled in the art can make correction and substitution of the embodiment without departing from the spirit of the present invention. In other words, the present invention has been disclosed in a form of illustration and should not be limitedly interpreted. To judge the gist of the present invention, the patent claims should be taken into account.

The series of processing explained in this specification can be executed by hardware, software, or a combination of the hardware and the software. When the processing by the software is executed, it is possible to install a program having a processing sequence recorded therein in a memory in a computer incorporated in dedicated hardware and cause the computer to execute the program or install the program in a general-purpose computer, which can execute various kinds of processing, and cause the general-purpose computer to execute the program. For example, the program can be recorded in a recording medium in advance. Besides installing the program from the recording medium to the computer, the program can be received through a network such as a LAN (Local Area Network) or the Internet and installed in a recording medium such as a built-in hard disk or the like.

The various kinds of processing described in this specification are not only executed in time series according to the description but may be executed in parallel or individually according to a processing ability of an apparatus that executes the processing or when necessary. In this specification, a system is a configuration of a logical set of plural apparatuses and is not limited to a system in which apparatuses having individual configurations are provided in an identical housing.

As described above, according to the embodiment of the present invention, event information including the identification data of users is inputted on the basis of image information or sound information acquired by a camera or a microphone is inputted to execute the update of target data set with a plurality of user confidence factors to generate user identification information. The simultaneous occurrence probability (joint probability) of candidate data that allows the targets to corresponding to the respective users is updated on the basis of user identification information included in the event information. The updated value of simultaneous occurrence probability is used for the calculation of the user confidence factor corresponding to the target. Thus, the processing for identifying a user can be efficiently performed at high precision without mistaking different targets for the same user.

The present application contains subject matter related to that disclosed in Japanese Priority Patent Application JP 2008-177609 filed in the Japan Patent Office on Jul. 8, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a plurality of information input units that input information including image information or sound information in an actual space;
an event detecting unit that generates event information including estimated identification information of users present in said actual space by analyzing said event information inputted from said information input unit; and
an information-integration processing unit that sets probability distribution data of hypotheses concerning identification information of the users and executes processing of identifying the users present in said actual space by updating and selecting the hypotheses on the basis of said event information, wherein
said information-integration processing unit executes processing for updating target data including user confidence factor information that indicates which of the users corresponds to a target provided as an event occurrence source on the basis of user identification information included in said event information, and
said information-integration processing unit executes processing for calculating said user confidence factor by applying a limitation of that identical user does not present simultaneously to the processing for updating said target data.

2. The information processing apparatus according to claim 1, wherein
said information-integration processing unit updates simultaneous occurrence probability (joint probability) of candidate data that allows the targets to corresponding to the respective users on basis of user identification information included in said event information, and
said information-integration processing unit applies the updated value of said simultaneous occurrence probability to processing for calculating a user confidence factor corresponding to a target and executes such processing.

3. The information processing apparatus according to claim 2, wherein
said information-integration processing unit marginalizes the value of said updated simultaneous occurrence probability on the basis of user identification information included in said event information to calculate the confidence factor of an user identifier corresponding to each target.

4. The information processing apparatus according to claim 2, wherein
said information-integration processing unit performs initial setting for the simultaneous occurrence probability (Joint Probability) of candidate data that allows the targets to corresponding to the respective users on the basis of a limitation of that the same user identifier (User ID) is not allocated to plural targets, wherein
the probability value of said simultaneous occurrence probability P(Xu) of candidate data where the same user identifier (User ID) is set to different targets is
P(Xu)=0.0; and
the probability value of other target data is
P(xu)=0.0<P≦1.0.

5. The information processing apparatus according to claim 4, wherein
said information-integration processing unit executes exceptional-setting processing that the probability value of said simultaneous occurrence probability P(Xu) is
P(XU)=0.0<P≦1.0
even if the same user identifier (User ID-unknown) is set to different targets with respect to an unregistered user set with a user identifier (User ID-unknown).

6. The information processing apparatus according to claim 1, wherein
said information-integration processing unit deletes the candidate data where the same user identifier (User ID) is set to different targets, while only leaving other candidate data, and
only the remaining candidate data is provided as an update subject on the basis of said event information.

7. The information processing apparatus according to claim 2, wherein
said information-integration processing unit employs a probability value calculated using a formula:
P(Xuₜ|θₜ,zuₜ,Xuₜ₋₁)
=R×P(θₜ,zuₜ|Xuₜ)P(Xuₜ₋₁|Xuₜ)P(Xuₜ)/P(Xuₜ₋₁)
where R denotes a normalization term, wherein
the formula is established by hypothesizing:
uniform probability P(θₜ, zuₜ) of that an observed value (Zuₜ) is event information corresponding to identification information obtained at time t, is provided as a generation source of a target (θ) and is assumed to be non-uniform when executing processing for calculating said simultaneous occurrence probability (joint probability); and
target information [Xu] that indicates a state of ser identification information {xuₜ¹, xuₜ², . . . , xuₜⁿ} included in target data at time t and is assumed to be uniform.

8. The information processing apparatus according to claim 7, wherein
said information-integration processing unit executes marginalization processing for the probability value P (Xu) when the probability representing a confidence factor corresponding to each target by using a formula:
P(xuⁱ)=Σ_{Xu=xui}P(Xu)
where i denotes a denotes a target identifier (tID) for calculating the probability of the confidence factor of the user identifier, and
said information-integration processing unit employs said formula to calculate the probability of representing a confidence factor of the user identifier corresponding to each target.

9. The information processing apparatus according to claim 2, wherein
said information-integration processing unit executes processing for marginalizing the value of said simultaneous occurrence probability set to candidate data including a target to be deleted to remaining candidate date after deletion of the target, and
processing for normalizing the total value of said simultaneous occurrence probability to be set to all the candidate data to 1 (one).

10. The information processing apparatus according to claim 2, wherein
when an additional target is generated and added to candidate data, said information-integration processing unit executes:
processing for allocating states corresponding to the number of users to additional candidate data increased by the addition of the generated target, and distributing the value of said simultaneous occurrence probability set to the existing candidate data to the additional candidate data; and
processing for normalizing the total value of said simultaneous occurrence probability set to all the candidate data to 1 (one).

11. An information processing method to be executed in an information processing apparatus having an information input unit and an event detecting unit, comprising the steps of:
inputting information into said event detecting unit by an information input unit, where the information includes either image information or sound information in actual space; and
allowing said event detecting unit to generate event information by analyzing the information input from said information input unit, where said event information includes estimated identification information of a user present in said actual space; and
executing information-integrating processing in which an information-integration processing unit sets probability-distribution data of hypotheses for user identification information and executes processing of identifying the user present in said actual space by updating and selecting the hypothesis on the basis of said event information, wherein
the step of information-integrating processing includes a step of executing processing for updating target data on the basis of user identification information included in said event information, where the target data is one that contains user confidence factor information representing which of users corresponds to the target provided as said event occurrence source, and
said information-integration processing unit executes processing for calculating the user confidence factor by applying a limitation of that the same user does not present simultaneously to the processing for updating the target data.

12. The information-processing method according to claim 11, wherein
said information-integrating step updates said simultaneous occurrence probability (joint probability) of candidate data that allows the targets to corresponding to the respective users on basis of user identification information included in said event information; and
said information-integrating step applies the updated value of simultaneous occurrence probability to processing for calculating a user confidence factor corresponding to a target and executes such processing.

13. A computer program for allowing a information processing apparatus having an information input unit and an event detecting unit to execute information processing, comprising the steps of:
inputting information into said event detecting unit by said information input unit, where the information includes either image information or sound information in actual space; and
generating event information from said event information by analyzing the information input from said information input unit, where said event information includes estimated identification information of a user present in said actual space; and
executing information-integrating processing in which an information-integration processing unit sets probability-distribution data of hypotheses for user identification information and executes processing of identifying the user present in said actual space by updating and selecting the hypothesis on the basis of the event information, wherein
the step of information-integrating processing includes a step of executing processing for updating target data on the basis of user identification information included in said event information, where the target data is one that contains user confidence factor information representing which of users corresponds to the target provided as the event occurrence source, and
said information-integration processing unit executes processing for calculating the user confidence factor by applying a limitation of that the same user does not present simultaneously to the processing for updating the target data.

14. The computer program according to claim 13, wherein
said information-integrating step updates said simultaneous occurrence probability (joint probability) of candidate data that allows the targets to corresponding to the respective users on basis of user identification information included in said event information; and
said information-integrating step applies the updated value of simultaneous occurrence probability to processing for calculating a user confidence factor corresponding to a target and executes such processing.
